(19) United States
(12) Patent Application Publication
(10) Pub. No.: US 2022/0129967 A1
(43) Pub. Date: Apr. 28, 2022

(54) SYSTEMS AND METHODS FOR PROVIDING TRANSACTION SERVICES

(71) Applicant: BEIJING DIDI INFINITY TECHNOLOGY AND DEVELOPMENT CO., LTD., Beijing (CN)

(72) Inventors: Rongbo JIN, Mountain View, CA (US); Zheng BU, Mountain View, CA (US); Shanxiang QI, Mountain View, CA (US)

(73) Assignee: BEIJING DIDI INFINITY TECHNOLOGY AND DEVELOPMENT CO., LTD., Beijing (CN)

(21) Appl. No.: 17/083,233

(22) Filed: Oct. 28, 2020

(51) Int. Cl. G06Q 30/06; G06Q 50/14; G06Q 20/40; G06Q 20/42; G06N 20/00

(52) U.S. Cl. CPC G06Q 30/0633; G06Q 50/14; G06N 20/00; G06Q 20/42; G06Q 20/405

(57) ABSTRACT

The present disclosure provides systems and methods for providing a transaction service when a service provider is providing a travel service to a service requester according to a travel service order through an online to offline service platform. The method may include receiving, through the online to offline service platform, a first request for the transaction service from a first terminal associated with the service requester, when a service provider is providing the travel service to the service requester. The method may include determining whether a condition for the transaction service is satisfied. In response to determining that the condition is satisfied, the method may also include generating a transaction service order for the transaction service. The method may further include providing the transaction service according to the transaction service order by using an account of the service provider.

### TECHNICAL FIELD

The present disclosure generally relates to online to offline (O2O) platforms, and more specifically, to methods and systems for providing transaction services through an online to offline service platform.

### BACKGROUND

With the development of technology, internet-based services such as online taxi-calling services and online transaction services, etc., have become increasingly popular because of their convenience and effectiveness. For example, using some online payment services (e.g. PAYPAL), users may be able to recharge or pay the bills for their mobile service or even electricity or water. However, due to various reasons (e.g., no bank account, lack of credit history, etc.), some users do not have access to online payment services and are forced to use inconvenient and time consuming payment relay methods, such as going to a convenience store or retail outlet and lining up to make cash payments, often with a premium on top, so that the store of outlet can conduct third-payment transaction for the user. Therefore, it is desirable to provide methods and systems for providing transaction services (e.g., payment services) with improved efficiency and convenience.

### SUMMARY

In a first aspect of the present disclosure, a system for providing a transaction service when a service provider is providing a travel service to a service requester according to a travel service order through an online to offline service platform is provided. The system may include at least one storage device storing executable instructions; and at least one processor in communication with the at least one storage device. When executing the executable instructions, the at least one processor may be configured to cause the system to perform operations including receiving, through the online to offline service platform, a first request for the transaction service from a first terminal associated with the service requester, when a service provider is providing the travel service to the service requester. The operations may also include determining whether a condition for the transaction service is satisfied and in response to determining that the condition is satisfied, generating a transaction service order for the transaction service. The operations may further include providing the transaction service according to the transaction service order by using an account of the service provider.

In some embodiments, the transaction service may be a payment on behalf of the service requester.

In some embodiments, the operations may further include receiving, through the online to offline service platform, a confirmation of the transaction service order from a second terminal associated with the service provider, wherein the confirmation of the transaction service order indicates that the service provider receives an amount of cash from the service requester.

In some embodiments, the operations may further include transmitting a notification relating to the travel service order and the transaction service order to the second terminal, and receiving the confirmation that the service provider receives the amount of cash including an amount for the transaction service order and an amount for the travel service order from the service requester.

In some embodiments, the operations may further include sending, by the at least one processor, a second request for the transaction service to a transaction service carrier, the transaction service carrier deducting an amount for the transaction service order from the account of the service provider in response to receiving the second request.

In some embodiments, the generating a transaction service order for the transaction service may include determining, based on first historical order data of the service requester, a first maximum transaction amount for the transaction service, determining, based on second historical order data of the service provider, a second maximum transaction amount for the transaction service, and providing, based on the first maximum transaction amount and the second maximum transaction amount, one or more reference transaction amounts for the service requester to select from; and receiving, from the first terminal, a confirmation of an amount for the transaction service order that is selected from the one or more reference transaction amounts by the service requester.

In some embodiments, the generating a transaction service order for the transaction service may include determining, based on first historical order data of the service requester, a first maximum transaction amount for the transaction service, determining, based on second historical order data of the service provider, a second maximum transaction amount for the transaction service, and receiving, from the first terminal, a confirmation of an amount for the transaction service order inputted by the service requester, wherein the amount of the transaction service order is less than the first maximum transaction amount and the second maximum transaction amount.

In some embodiments, the condition for the transaction service may be determined to be satisfied when one or more of the following are satisfied: determining, based on first historical order data associated with the service requester, whether a first condition associated with the service requester is satisfied; determining, based on second historical order data associated with the service provider, whether a second condition associated with the service provider is satisfied; and determining, based on order information of at least one of the travel service order or the transaction service order, whether a third condition associated with at least one of the travel service order or the transaction service order is satisfied.

In some embodiments, the first condition may be associated with at least one of: a first count of historical orders of the service requester for the transaction service in a time period being less than a first predetermined order number for the service requester, a second count of historical orders of the service requester for the transaction service during the travel service order in progress being less than a second predetermined order number for the service requester, a maximum transaction amount of the service requester for the transaction service exceeding a predetermined amount threshold for the service requester, an evaluation of the service requester for receiving at least one of the travel service or the transaction service satisfying an evaluation condition for the service requester, or a violation record of the service requester for receiving at least one of the travel service or the transaction service satisfying a violation condition for the service requester.

In some embodiments, the second condition may be associated with at least one of: a first count of historical orders of the service provider for the transaction service in a time period being less than a first predetermined order number for the service provider, a second count of historical orders of the service provider for the transaction service during the transaction service order in progress being less than a second predetermined order number for the service provider, a maximum transaction amount of the service provider for the transaction service exceeding a predetermined amount threshold for the service provider, an evaluation of the service provider for providing at least one of the travel service or the transaction service satisfies an evaluation condition for the service provider, or a violation record of the service provider for providing at least one of the travel service or the transaction service satisfies a violation condition for the service provider.

In some embodiments, the third condition may be associated with a type of the travel service order.

In some embodiments, the determining whether a condition for the transaction service is satisfied may include obtaining a trained machine learning model and historical order data associated with at least one of the service requester or the service provider, and determining, based at least in part, on the historical order data, whether the condition for the transaction service is satisfied using the trained machine learning model.

In a second aspect of the present disclosure, a system is provided. The system may include at least one storage device storing executable instructions; and at least one processor in communication with the at least one storage device. When executing the executable instructions, the at least one processor may be configured to cause the system to perform operations including receiving, through an online to offline service platform, a request for a transaction service from a first terminal of a service requester, one or more first conditions associated with the service requester being satisfied. The transaction service may be a payment on behalf of the service requester. The operations may further include determining a service provider for providing the transaction service, one or more second conditions associated with the service provider being satisfied and generating a transaction service order, and providing the transaction service according to the transaction service order by using an account of the service provider.

In some embodiments, the operations may further include sending, through the online to offline service platform, the transaction service order to a second terminal of the service provider, and receiving, through the online to offline service platform, a confirmation of the transaction service order from a second terminal associated with the service provider. The confirmation of the transaction service order from the second terminal may indicate that the service provider receives an amount of cash from the service requester.

In some embodiments, the first condition may be associated with at least one of: a count of historical orders of the service requester for the transaction service in a time period being less than a predetermined order number, a maximum transaction amount of the service requester for the transaction service exceeding a predetermined amount threshold, an evaluation of the service requester for receiving the transaction service satisfying an evaluation condition, or a violation record of the service requester for receiving the transaction service satisfying a violation condition.

In some embodiments, the second condition may be associated with at least one of: a count of historical orders of the service provider for the transaction service in a time period being less than a predetermined order number, a maximum transaction amount of the service provider for the transaction service exceeds a predetermined amount threshold, an evaluation of the service provider for providing the transaction service satisfies an evaluation condition, or a violation record of the service provider for providing the transaction service satisfies a violation condition.

In some embodiments, the generating a transaction service order for the transaction service may include determining, based on first historical order data of the service requester, a first maximum transaction amount for the transaction service, determining, based on second historical order data of the service provider, a second maximum transaction amount for the transaction service, and receiving, from the first terminal, a confirmation of an amount for the transaction service order inputted by the service requester. The amount of the transaction service order may be less than the first maximum transaction amount and the second maximum transaction amount.

In a third aspect of the present disclosure, a method for providing a transaction service when a service provider is providing a travel service to a service requester according to a travel service order through an online to offline service platform is provided. The method may be implemented on a computing device including at least one processor and a storage device. The method may include receiving, through the online to offline service platform, a first request for a transaction service from a first terminal associated with the service requester, when a service provider is providing the travel service to the service requester. The method may also include determining whether a condition for the transaction service is satisfied and in response to determining that the condition is satisfied, generating a transaction service order for the transaction service. The method may further include providing the transaction service according to the transaction service order by using an account of the service provider.

In some embodiments, the method may further include receiving, through the online to offline service platform, a confirmation of the transaction service order from a second terminal associated with the service provider. The confirmation of the transaction service order may indicate that the service provider receives an amount of cash from the service requester.

In some embodiments, the condition for the transaction service may be satisfied when one or more of the following are satisfied: determining, based on first historical order data associated with the service requester, whether a first condition associated with the service requester is satisfied; determining, based on second historical order data associated with the service provider, whether a second condition associated with the service provider is satisfied; and determining, based on order information of at least one of the travel service order or the transaction service order, whether a third condition associated with at least one of the travel service order or the transaction service order is satisfied.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities, and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating an exemplary online to offline (O2O) service system according to some embodiments of the present disclosure;

FIG. 2 is a schematic diagram illustrating an exemplary computing device according to some embodiments of the present disclosure;

FIG. 3 is a schematic diagram illustrating exemplary hardware and/or software components of a mobile device on which a terminal may be implemented according to some embodiments of the present disclosure;

FIGS. 4A-4B are block diagrams illustrating an exemplary processing engine according to some embodiments of the present disclosure;

FIG. 5 is a flowchart illustrating an exemplary process for providing a transaction service according to some embodiments of the present disclosure;

FIG. 6 is a flowchart illustrating an exemplary training process of a trained machine learning model according to some embodiments of the present disclosure;

FIG. 7 is a flowchart illustrating an exemplary process for determining a transaction amount according to some embodiments of the present disclosure;

FIG. 8 is a flowchart illustrating an exemplary process for providing a transaction service according to some embodiments of the present disclosure; and

FIGS. 9A-9L are block diagrams illustrating an exemplary process for providing a transaction service through user interfaces of terminal devices according to some embodiments of the present disclosure.

### DETAILED DESCRIPTION

In the following detailed description, numerous specific details are set forth by way of examples in order to provide a thorough understanding of the relevant disclosure. However, it should be apparent to those skilled in the art that the present disclosure may be practiced without such details. In other instances, well-known methods, procedures, systems, components, and/or circuitry have been described at a relatively high-level, without detail, in order to avoid unnecessarily obscuring aspects of the present disclosure. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

It will be understood that the term “system,” “engine,” “unit,” “module,” and/or “block” used herein are one method to distinguish different components, elements, parts, section, or assembly of different levels in ascending order. However, the terms may be displaced by another expression if they achieve the same purpose.

Generally, the word “module,” “unit,” or “block,” as used herein, refers to logic embodied in hardware or firmware, or to a collection of software instructions. A module, a unit, or a block described herein may be implemented as software and/or hardware and may be stored in any type of non-transitory computer-readable medium or other storage device. In some embodiments, a software module/unit/block may be compiled and linked into an executable program. It will be appreciated that software modules can be callable from other modules/units/blocks or from themselves, and/or may be invoked in response to detected events or interrupts. Software modules/units/blocks configured for execution on computing devices may be provided on a computer-readable medium, such as a compact disc, a digital video disc, a flash drive, a magnetic disc, or any other tangible medium, or as a digital download (and can be originally stored in a compressed or installable format that needs installation, decompression, or decryption prior to execution). Such software code may be stored, partially or fully, on a storage device of the executing computing device, for execution by the computing device. Software instructions may be embedded in a firmware, such as an erasable programmable read-only memory (EPROM). It will be further appreciated that hardware modules/units/blocks may be included in connected logic components, such as gates and flip-flops, and/or can be included of programmable units, such as programmable gate arrays or processors. The modules/units/blocks or computing device functionality described herein may be implemented as software modules/units/blocks, but may be represented in hardware or firmware. In general, the modules/units/blocks described herein refer to logical modules/units/blocks that may be combined with other modules/units/blocks or divided into sub-modules/sub-units/sub-blocks despite their physical organization or storage. The description may be applicable to a system, an engine, or a portion thereof.

It will be understood that when a unit, engine, module, or block is referred to as being “on,” “connected to,” or “coupled to,” another unit, engine, module, or block, it may be directly on, connected or coupled to, or communicate with the other unit, engine, module, or block, or an intervening unit, engine, module, or block may be present, unless the context clearly indicates otherwise. As used herein, the term “and/or” includes any and all combinations of one or more of the associated listed items.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

The flowcharts used in the present disclosure illustrate operations that systems implement according to some embodiments in the present disclosure. It is to be expressly understood, the operations of the flowchart may be implemented not in order. Conversely, the operations may be implemented in inverted order, or simultaneously. Moreover, one or more other operations may be added to the flowcharts. One or more operations may be removed from the flowcharts.

Embodiments of the present disclosure may be applied to different transportation systems including but not limited to land transportation, sea transportation, air transportation, space transportation, or the like, or any combination thereof. A vehicle of the transportation systems may include a rickshaw, travel tool, taxi, chauffeured car, hitch, bus, rail transportation (e.g., a train, a bullet train, high-speed rail, and subway), ship, airplane, spaceship, hot-air balloon, driverless vehicle, or the like, or any combination thereof. The transportation system may also include any transportation system that applies management and/or distribution, for example, a system for sending and/or receiving an express.

The application scenarios of different embodiments of the present disclosure may include but not limited to one or more webpages, browser plugins and/or extensions, client terminals, custom systems, intracompany analysis systems, artificial intelligence robots, or the like, or any combination thereof. It should be understood that application scenarios of the system and method disclosed herein are only some examples or embodiments. Those having ordinary skills in the art, without further creative efforts, may apply these drawings to other application scenarios. For example, other similar servers.

The term “passenger,” “requester,” “requester,” “service requester,” “service requester,” and “customer” in the present disclosure are used interchangeably to refer to an individual, an entity, or a tool that may request or order a service. Also, the term “driver,” “provider,” “service provider,” and “supplier” in the present disclosure are used interchangeably to refer to an individual, an entity, or a tool that may provide a service or facilitate the providing of the service. The term “user” in the present disclosure may refer to an individual, an entity, or a tool that may request a service, order a service, provide a service, or facilitate the providing of the service. For example, the user may be a requester, a passenger, a driver, an operator, or the like, or any combination thereof. In the present disclosure, “requester” and “requester terminal” may be used interchangeably, and “provider” and “provider terminal” may be used interchangeably.

The term “request,” “service,” “service request,” and “order” in the present disclosure are used interchangeably to refer to a request that may be initiated by a passenger, a requester, a service requester, a customer, a driver, a provider, a service provider, a supplier, or the like, or any combination thereof. The service request may be accepted by any one of a passenger, a requester, a service requester, a customer, a driver, a provider, a service provider, or a supplier. The service request may be chargeable or free.

The positioning technology used in the present disclosure may be based on a global positioning system (GPS), a global navigation satellite system (GLONASS), a compass navigation system (COMPASS), a Galileo positioning system, a quasi-zenith satellite system (QZSS), a wireless fidelity (WiFi) positioning technology, or the like, or any combination thereof. One or more of the above positioning systems may be used interchangeably in the present disclosure.

Provided herein are systems and methods for providing transaction services with improved convenience and/or efficiency. In some embodiments, the systems may receive, through an online to offline service platform, a first request for a transaction service from a first terminal associated with a service requester, when a service provider is providing a travel service to the service requester according to a travel service order through the online to offline service platform; the systems may determine whether a condition for the transaction service is satisfied; in response to determining that the condition is satisfied, the systems may generate a transaction service order for the transaction service; further, the systems may provide the transaction service according to the transaction service order by using an account of the service provider.

Accordingly, the transaction service may be provided for the service requester during the travel service by using the account of the service provider when the service requester does not have access to online payment services. The service requester does not need to go to a convenience store or retail outlet and line up for hours to make cash payments, which improves convenience and efficiency for transaction services. Besides, the systems may determine whether the condition for the transaction service is satisfied and the systems may provide the transaction service for the service requester when the condition for the transaction service is satisfied, which may avoid fraud and bad debt, thereby improving the safety of the transaction service.

In some embodiments, a trained machine learning model may be used to determine whether the condition for the transaction service is satisfied. The trained machine learning model may be obtained based on historical order data provided by the online to the offline platform. The trained machine learning model may determine whether a condition for the transaction service associated with at least one of the service requester or the service provider is satisfied by learning from the historical order data, which improves the accuracy and efficiency of determining whether the condition for the transaction service is satisfied. Further, using the trained machine learning model, the computing speed for determining whether the condition for the transaction service is satisfied. Therefore, the safety and/or efficiency of providing the transaction service may be further improved.

It should be noted that online to offline services, such as online taxi-hailing, online transaction service, etc., is a new form of service rooted only in the post-Internet era. It provides technical solutions to users and service providers that could raise only in the post-Internet era. In the pre-Internet era, when a user hails a taxi on the street, the taxi request and acceptance occur only between the passenger and one taxi driver that sees the passenger. If the passenger hails a taxi through a telephone call, the service request and acceptance by a service provider may occur only between the passenger and the service provider (e.g., a taxi company or agent). Online taxi, however, allows a user of the service to reserve a service and automatically distribute the reservation service request to a vast number of individual service providers (e.g., taxi drivers) distance away from the user. It also allows a plurality of service providers to respond to the service request simultaneously and in real-time. Therefore, through the Internet, the online to offline transportation systems may provide a much more efficient transaction platform for the users and the service providers that may never meet in a traditional pre-Internet travel service system. Allocating appointment orders provides a service for both requesters and service providers efficiently.

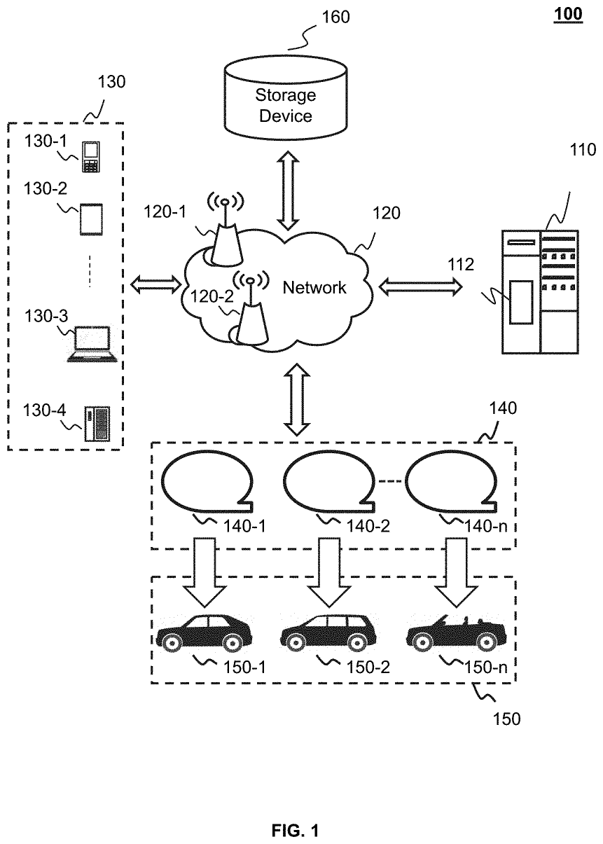

FIG. 1 is a schematic diagram illustrating an exemplary online to offline (O2O) service system 100 according to some embodiments of the present disclosure. The O2O service system 100 may provide a plurality of online to offline services. Exemplary services may include a transaction service, a travel service or the like, or a combination thereof. The travel service may include a taxi-hailing service, a chauffeur service, an express car service, a carpool service, a bus service, a driver hire service, a shuttle service, etc. The transaction service may include a prepaid refill service, a payment service, a credit repayment service, etc.

In some embodiments, the O2O service system 100 may provide other online services, such as booking a meal, shopping, navigation, or the like, or any combination thereof. For example, the O2O service system 100 may include an online travel service platform for travel services. The O2O service system 100 may include a server 110, a network 120, a requester terminal 130, a provider terminal 140, a vehicle 150, and a storage device 160.

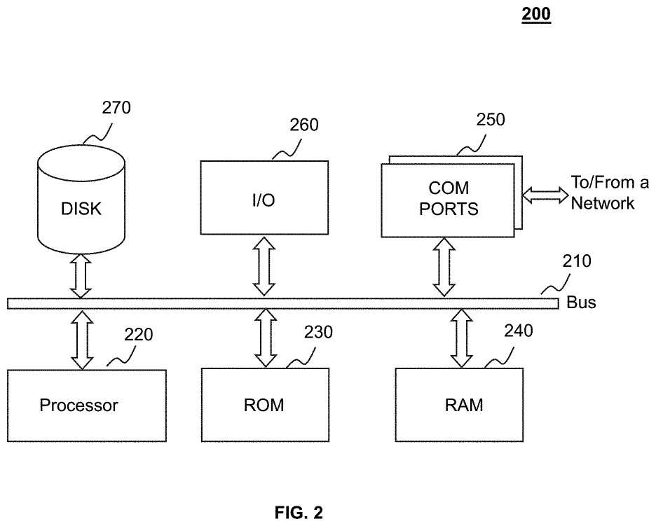

In some embodiments, the server 110 may be a single server or a server group. The server group may be centralized, or distributed (e.g., the server 110 may be a distributed system). In some embodiments, the server 110 may be local or remote. For example, the server 110 may access information and/or data in the requester terminal 130, the provider terminal 140, and/or the storage device 160 via the network 120. As another example, the server 110 may be directly connected to the requester terminal 130, the provider terminal 140, and/or the storage device 160 to access information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device 200 having one or more components illustrated in FIG. 2 in the present disclosure.

In some embodiments, the server 110 may include a processing engine 112. The processing engine 112 may process information and/or data related to a service request to perform one or more functions described in the present disclosure. For example, the processing engine 112 may determine whether one or more conditions for a transaction service are satisfied after receiving a first request for the transaction service from the requester terminal 130 of a service requester when a service provider is providing a travel service to the service requester according to a travel service order through the online to offline service system 100. In response to determining that the condition is satisfied, the processing engine 112 may generate a transaction service order for the transaction service, and provide the transaction service according to the transaction service order by using an account of the service provider of the provider terminal 140. As another example, the processing engine 112 may send a second request for the transaction service to a transaction service carrier. The transaction service carrier may deduct the amount for the transaction service order from the account of the service provider in response to receiving the second request. As still another example, the processing engine 112 may receive a third request for the travel service from the requester terminal 130 associated with the service requester and dispatch the third request to the provider terminal 140. In response to receiving a confirmation of the third request from the provider terminal 140, the processing engine 112 may generate the travel service order.

In some embodiments, the processing engine 112 may include one or more processing engines (e.g., single-core processing engine(s) or multi-core processor(s)). Merely by way of example, the processing engine 112 may include a central processing unit (CPU), an application-specific integrated circuit (ASIC), an application-specific instruction-set processor (ASIP), a graphics processing unit (GPU), a physics processing unit (PPU), a digital signal processor (DSP), a field-programmable gate array (FPGA), a programmable logic device (PLD), a controller, a microcontroller unit, a reduced instruction-set computer (RISC), a microprocessor, or the like, or any combination thereof.

The network 120 may facilitate exchange of information and/or data. In some embodiments, one or more components of the O2O service system 100 (e.g., the server 110, the requester terminal 130, the provider terminal 140, the vehicle 150, and the storage device 160) may transmit information and/or data to other component(s) of the O2O service system 100 via the network 120. For example, the server 110 may receive a service request from the requester terminal 130 via the network 120. In some embodiments, the network 120 may be any type of wired or wireless network, or combination thereof. Merely by way of example, the network 120 may include a cable network, a wireline network, an optical fiber network, a telecommunications network, an intranet, an Internet, a local area network (LAN), a wide area network (WAN), a wireless local area network (WLAN), a metropolitan area network (MAN), a wide area network (WAN), a public telephone switched network (PSTN), a Bluetooth network, a ZigBee network, a near field communication (NFC) network, or the like, or any combination thereof. In some embodiments, the network 120 may include one or more network access points. For example, the network 120 may include wired or wireless network access points such as base stations and/or internet exchange points 120-1, 120-2, through which one or more components of the O2O service system 100 may be connected to the network 120 to exchange information and/or data.

In some embodiments, a service requester who requests an O2O service may be an owner of the requester terminal 130. For example, a passenger may be an owner of the requester terminal 130. In some embodiments, the owner of the requester terminal 130 may be someone other than the passenger. For example, an owner A of the requester terminal 130 may use the requester terminal 130 to transmit a service request for a passenger B or receive a service confirmation and/or information or instructions from the server 110. In some embodiments, a service provider may be a user of the provider terminal 140. In some embodiments, the user of the provider terminal 140 may be someone other than the service provider. For example, a user C of the provider terminal 140 may use the provider terminal 140 to receive a service request for a service provider D, and/or information or instructions from the server 110. In some embodiments, “passenger” and “passenger terminal” may be used interchangeably, and “service provider” and “provider terminal” may be used interchangeably. In some embodiments, the provider terminal may be associated with one or more service providers (e.g., a night-shift service provider, or a day-shift service provider).

In some embodiments, the requester terminal 130 may include a mobile device 130-1, a tablet computer 130-2, a laptop computer 130-3, a built-in device in a vehicle 130-4, or the like, or any combination thereof. In some embodiments, the mobile device 130-1 may include a smart home device, a wearable device, a smart mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a smart bracelet, a smart footgear, smart glasses, a smart helmet, a smart watch, smart clothing, a smart backpack, a smart accessory, or the like, or any combination thereof. In some embodiments, the smart mobile device may include a smartphone, a personal digital assistance (PDA), a gaming device, a navigation device, a point of sale (POS) device, or the like, or any combination thereof. In some embodiments, the virtual reality device and/or the augmented reality device may include a virtual reality helmet, a virtual reality glass, a virtual reality patch, an augmented reality helmet, augmented reality glasses, an augmented reality patch, or the like, or any combination thereof. For example, the virtual reality device and/or the augmented reality device may include a Google™ Glass, an Oculus Rift, a HoloLens, a Gear VR, etc. In some embodiments, the built-in device in the vehicle 130-4 may include an onboard computer, an onboard television, etc. In some embodiments, the requester terminal 130 may be a device with positioning technology for locating the position of the passenger and/or the requester terminal 130.

In some embodiments, a service provider who provides an O2O service may be an owner of one of the provider terminal 140. The provider terminal 140 may include provider terminals 140-1, 140-2, . . . , 140-n. In some embodiments, the provider terminal 140 may be similar to, or the same device as the requester terminal 130. In some embodiments, the provider terminal 140 may be customized to be able to implement the online on-demand travel service. In some embodiments, the provider terminal 140 may be a device with positioning technology for locating the service provider, the provider terminal 140, and/or a vehicle 150 associated with the provider terminal 140. In some embodiments, the requester terminal 130 and/or the provider terminal 140 may communicate with another positioning device to determine the position of the passenger, the requester terminal 130, the service provider, and/or the provider terminal 140. In some embodiments, the requester terminal 130 and/or the provider terminal 140 may periodically transmit the positioning information to the server 110. In some embodiments, the provider terminal 140 may also periodically transmit the availability status to the server 110. The availability status may indicate whether a vehicle 150 associated with the provider terminal 140 is available to carry a passenger. For example, the requester terminal 130 and/or the provider terminal 140 may transmit the positioning information and the availability status to the server 110 every thirty minutes. As another example, the requester terminal 130 and/or the provider terminal 140 may transmit the positioning information and the availability status to the server 110 each time the user logs into the mobile application associated with the online on-demand travel service.

In some embodiments, the provider terminal 140 may correspond to one or more vehicles 150. The vehicles 150 may carry the passenger and travel to the destination. The vehicles 150 may include a plurality of vehicles 150-1, 150-2, . . . , 150-n. In some embodiments, one vehicle may correspond to one type of travel services (e.g., a taxi-hailing service, a chauffeur service, an express car service, a carpool service, a bus service, a driver hire service, or a shuttle service).

The storage device 160 may store data and/or instructions. In some embodiments, the storage device 160 may store data obtained from the requester terminal 130 and/or the provider terminal 140. In some embodiments, the storage device 160 may store data and/or instructions that the server 110 may execute or use to perform exemplary methods described in the present disclosure. In some embodiments, the storage device 160 may include a mass storage, removable storage, a volatile read-and-write memory, a read-only memory (ROM), or the like, or any combination thereof. Exemplary mass storage may include a magnetic disk, an optical disk, solid-state drives, etc. Exemplary removable storage may include a flash drive, a floppy disk, an optical disk, a memory card, a zip disk, a magnetic tape, etc. Exemplary volatile read-and-write memory may include a random-access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (EPROM), an electrically-erasable programmable ROM (EEPROM), a compact disk ROM (CD-ROM), and a digital versatile disk ROM, etc. In some embodiments, the storage device 160 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage device 160 may be connected to the network 120 to communicate with one or more components of the O2O service system 100 (e.g., the server 110, the requester terminal 130, or the provider terminal 140). One or more components of the O2O service system 100 may access the data or instructions stored in the storage device 160 via the network 120. In some embodiments, the storage device 160 may be directly connected to or communicate with one or more components of the O2O service system 100 (e.g., the server 110, the requester terminal 130, the provider terminal 140). In some embodiments, the storage device 160 may be part of the server 110.

In some embodiments, one or more components of the O2O service system 100 (e.g., the server 110, the requester terminal 130, the provider terminal 140) may have permissions to access the storage device 160. In some embodiments, one or more components of the O2O service system 100 may read and/or modify information related to the passenger, service provider, and/or the public when a condition is met. For example, the server 110 may read and/or modify one or more passengers' information after a service is completed. As another example, the server 110 may read and/or modify one or more service providers' information after a service is completed.

In some embodiments, information exchanging of one or more components of the O2O service system 100 may be initiated by way of requesting a service. The object of the service request may be any product. In some embodiments, the product may include food, medicine, commodity, chemical product, electrical appliance, clothing, car, housing, luxury, or the like, or any combination thereof. In some other embodiments, the product may include a servicing product, a financial product, a knowledge product, an internet product, or the like, or any combination thereof. The internet product may include an individual host product, a web product, a mobile internet product, a commercial host product, an embedded product, or the like, or any combination thereof. The mobile internet product may be used in a software of a mobile terminal, a program, a system, or the like, or any combination thereof. The mobile terminal may include a tablet computer, a laptop computer, a mobile phone, a personal digital assistance (PDA), a smart watch, a point of sale (POS) device, an onboard computer, an onboard television, a wearable device, or the like, or any combination thereof. For example, the product may be any software and/or application used on the computer or mobile phone. The software and/or application may relate to socializing, shopping, transporting, entertainment, learning, investment, or the like, or any combination thereof. In some embodiments, the software and/or application related to transporting may include a traveling software and/or application, a vehicle scheduling software and/or application, a mapping software and/or application, etc. In the vehicle scheduling software and/or application, the vehicle may include a horse, a carriage, a rickshaw (e.g., a wheelbarrow, a bike, a tricycle, etc.), a car (e.g., a taxi, a bus, a private car, etc.), a train, a subway, a vessel, an aircraft (e.g., an airplane, a helicopter, a space shuttle, a rocket, a hot-air balloon, etc.), or the like, or any combination thereof.

One of ordinary skill in the art would understand that when an element (or component) of the O2O service system 100 performs, the element may perform through electrical signals and/or electromagnetic signals. For example, when a requester terminal 130 transmits out a service request to the server 110, a processor of the requester terminal 130 may generate an electrical signal encoding the request. The processor of the requester terminal 130 may then transmit the electrical signal to an output port. If the requester terminal 130 communicates with the server 110 via a wired network, the output port may be physically connected to a cable, which further may transmit the electrical signal to an input port of the server 110. If the requester terminal 130 communicates with the server 110 via a wireless network, the output port of the requester terminal 130 may be one or more antennas, which convert the electrical signal to electromagnetic signal. Similarly, a provider terminal 130 may receive an instruction and/or service request from the server 110 via electrical signal or electromagnet signals. Within an electronic device, such as the requester terminal 130, the provider terminal 140, and/or the server 110, when a processor thereof processes an instruction, transmits out an instruction, and/or performs an action, the instruction and/or action is conducted via electrical signals. For example, when the processor retrieves or saves data from a storage medium, it may transmit out electrical signals to a read/write device of the storage medium, which may read or write structured data in the storage medium. The structured data may be transmitted to the processor in the form of electrical signals via a bus of the electronic device. Here, an electrical signal may refer to one electrical signal, a series of electrical signals, and/or a plurality of discrete electrical signals.

FIG. 2 is a schematic diagram illustrating an exemplary computing device according to some embodiments of the present disclosure. The computing device may be a computer, such as the server 110 in FIG. 1 and/or a computer with specific functions, configured to implement any particular system according to some embodiments of the present disclosure. Computing device 200 may be configured to implement any components that perform one or more functions disclosed in the present disclosure. For example, the server 110 may be implemented in hardware devices, software programs, firmware, or any combination thereof of a computer like computing device 200. For brevity, FIG. 2 depicts only one computing device. In some embodiments, the functions of the computing device, providing a function that providing transaction services and/or travel service requires, may be implemented by a group of similar platforms in a distributed mode to disperse the processing load of the system.

Computing device 200 may include a communication port 250 that may connect with a network that may implement the data communication. Computing device 200 may also include a processor 220 that is configured to execute instructions and includes one or more processors. The schematic computer platform may include an internal communication bus 210, different types of program storage units and data storage units (e.g., a disk 270, a read-only memory (ROM) 230, a random-access memory (RAM) 240), various data files applicable to computer processing and/or communication, and some program instructions executed possibly by the processor 220. Computing device 200 may also include an I/O device 260 that may support the input and output of data flow between computing device 200 and other components. Moreover, computing device 200 may receive programs and data via the communication network.

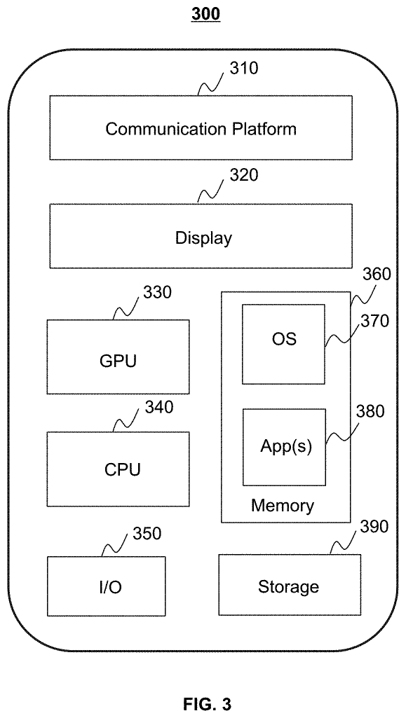

FIG. 3 is a schematic diagram illustrating exemplary hardware and/or software components of an exemplary mobile device 300 on which a terminal may be implemented according to some embodiments of the present disclosure. As illustrated in FIG. 3, the mobile device 300 may include a communication platform 310, a display 320, a graphic processing unit (GPU) 330, a central processing unit (CPU) 340, an I/O 350, a memory 360, a mobile operating system (OS) 370, and a storage 390. In some embodiments, any other suitable component, including but not limited to a system bus or a controller (not shown), may also be included in the mobile device 300.

In some embodiments, a mobile operating system 370 (e.g., iOS™′ Android™, Windows Phone™, etc.) and one or more applications 380 may be loaded into the memory 360 from the storage 390 in order to be executed by the CPU 340. The applications 380 may include a browser or any other suitable mobile apps for receiving and rendering information relating to data processing or other information from the O2O service system 100. User interactions with the information stream may be achieved via the I/O 350 and provided to the database, the server 105, and/or other components of the O2O service system 100. In some embodiments, the mobile device 300 may be an exemplary embodiment corresponding to the requester terminal 130 or the provider terminal 140.

To implement various modules, units, and their functionalities described in the present disclosure, computer hardware platforms may be used as the hardware platform(s) for one or more of the elements described herein. A computer with user interface elements may be used to implement a personal computer (PC) or any other type of work station or terminal device. A computer may also act as a system if appropriately programmed.

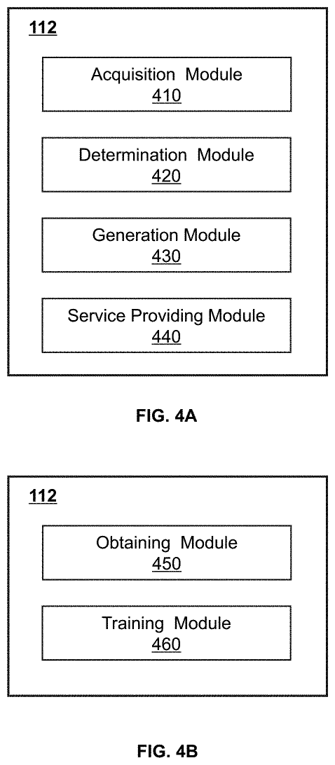

FIG. 4A is a block diagram illustrating an exemplary processing engine 112 according to some embodiments of the present disclosure. The processing engine 112 may include an acquisition module 410, a determination module 420, a generation module 430, and a service providing module 440. The modules may be hardware circuits of all or part of the processing engine 112. The modules may also be implemented as an application or set of instructions read and executed by the processing engine 112. Further, the modules may be any combination of the hardware circuits and the application/instructions. For example, the modules may be part of the processing engine 112 when the processing engine 112 is executing the application/set of instructions.

The acquisition module 410 may be configured to may receive, through an online to offline (O2O) service platform, a request (also referred to as a first request) for the transaction service from a first terminal associated with a service requester. The O2O service platform may be configured to provide online to offline services via a communication between terminals (e.g., the requester terminal 130, the provider terminal 140, etc.) and the O2O service platform through a network. The transaction service may be a payment on behalf of the service requester. In some embodiments, the acquisition module 410 may receive, through the O2O service platform, the first request for the transaction service from the first terminal when a service provider is providing a travel service to the service requester according to a travel service order (also referred to as a travel order) through the O2O service platform.

The determination module 420 may be configured to determine whether a condition for the transaction service is satisfied. In some embodiments, the determination module 420 may determine whether the condition for the transaction service is satisfied by determining, based on first historical order data associated with the service requester, whether a first condition associated with the service requester is satisfied, determining, based on second historical order data associated with the service provider, whether a second condition associated with the service provider is satisfied, determining, based on order information of at least one of the travel service order or the transaction service order, whether a third condition associated with at least one of the travel service order or the transaction service order is satisfied, or the like, or a combination thereof. In some embodiments, in response to determining that the first condition, the second condition, the third condition, etc., are all satisfied, the determination module 420 may determine that the condition for the transaction service is satisfied; in response to determining that at least one of the first condition, the second condition, or the third condition, etc., is unsatisfied, the determination module 420 may determine that the condition for the transaction service is not satisfied. In some embodiments, in response to determining that at least one of the first condition, the second condition, or the third condition, etc., is satisfied, the determination module 420 may determine that the condition for the transaction service is satisfied; in response to determining that none of the first condition, the second condition, and the third condition, etc., is satisfied, the determination module 420 may determine that the condition for the transaction service is not satisfied.

In some embodiments, the determination module 420 may also be configured to determine, based at least in part, on the historical order data (e.g., the first historical order data and/or the second historical order data), whether the condition for the transaction service is satisfied using a trained machine learning model. In some embodiments, the determination module 420 may input the historical order data (e.g., the first historical order data and the second historical data) into the trained machine learning model. An output result may be generated by the trained machine learning model. The output result of the trained machine learning model may include whether the condition for the transaction service is satisfied. In some embodiments, the determination module 420 may input the first historical order data and the second historical data) respectively into the trained machine learning model and generate a result corresponding to each of the first historical order data and the second historical data.

The generation module 430 may be configured to generate a transaction service order (also referred to as transaction order) for the transaction service in response to determining that the condition is satisfied. The transaction service order may correspond to the transaction service. In some embodiments, the transaction service order may include information and/or data related to the transaction service.

The generation module 430 may also be configured to provide, to the first terminal, a notification indicating that the transaction service is unavailable in response to determining that at least one of the one or more conditions is not satisfied. In some embodiments, the notification may include a reason why the transaction service is unavailable.

The service providing module 440 may be configured to provide the transaction service according to the transaction service order by using an account of the service provider. In some embodiments, the service providing module 440 may send the transaction order to the second terminal and receive, through the online to offline service platform, a confirmation of the transaction service order from the second terminal associated with the service provider. The confirmation of the transaction service order from the second terminal may indicate that the service provider receives an amount of cash from the service requester. In some embodiments, the service providing module 440 may send the travel order and the transaction order to the second terminal, and receive the confirmation that the service provider receives the amount of cash including the amount for the transaction service order and an amount for the travel service order from the service requester.

The service providing module 440 may also be configured to send, by the at least one processor, a request for the transaction service to a transaction service carrier. The transaction service carrier may provide the transaction service for the service requester through the account of the service provider.

It should be noted that the above descriptions of the processing engine 112 are merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, two or more modules may be integrated into one unit to perform the functions thereof. For example, the determination module 420 and the generation module 430 may be integrated into a single module to perform the functions thereof. In some embodiments, some other components/modules may be added into the processing engine 112. For example, the processing engine 112 may include a storage module.

FIG. 4B is a block diagram illustrating another exemplary processing engine according to some embodiments of the present disclosure. In some embodiments, processing engine 112 may be implemented on a computing device 200 (e.g., the processor 220) illustrated in FIG. 2 or a CPU 340 as illustrated in FIG. 3. As illustrated in FIG. 4B, the processing engine 112 may include an obtaining module 450 and a training module 460. Each of the modules described above may be a hardware circuit that is designed to perform certain actions, e.g., according to a set of instructions stored in one or more storage media, and/or any combination of the hardware circuit and the one or more storage media.

The obtaining module 450 may be configured to obtain a plurality of training samples. Each of the plurality of training samples may include historical order data associated with at least one of a sample service requester or a sample service provider.

Each of the plurality of training samples may include a determination of whether a condition fora transaction service is satisfied. The historical order data corresponding to each of the training samples may be annotated by determining whether the condition for the transaction service is satisfied. In some embodiments, a positive sample may be annotated with a label “1”; a negative sample may be annotated with a label “0.” The historical order data corresponding to each of the training samples may be used as input in the training process of a machine learning model. The determination of whether the condition for the transaction service is satisfied may be used as a reference output corresponding to the historical order data of each of the training samples in the training process of the machine learning model.

Each of the plurality of training samples may include a maximum transaction amount of at least one of a sample service requester or a sample service provider. The historical order data corresponding to each of the training samples may be used as input in the training process of a machine learning model. The maximum transaction amount may be used as a reference output corresponding to the historical order data of each of the training samples in the training process of the machine learning model. In some embodiments, the reference output may be predetermined by the system 100. For example, the system 100 may be predetermined the reference output according to a default setting of the system 100 or according to the historical order data.

The training module 460 may be configured to generate a trained machine learning model by training a machine learning model using the plurality of training samples in a training process. In some embodiments, the training module 460 may construct the trained machine learning model based on a deep learning model (e.g., a convolutional neural network (CNN) model, a deep belief nets (DBN) machine learning model, a stacked auto-encoder network), a recurrent neural network (RNN) model, a long short term memory (LSTM) network model, a fully convolutional neural network (FCN) model, a generative adversarial network (GAN) model, a backpropagation (BP) machine learning model, a radial basis function (RBF) machine learning model, an Elman machine learning model, or the like, or any combination thereof. The training module 460 may train the machine learning model based on the plurality of training samples using a training algorithm. In some embodiments, the training module 460 may perform a plurality of iterations to iteratively update one or more parameter values of the machine learning model to obtain the trained machine learning model. Before the plurality of iterations, the training module 460 may initialize the parameter values of the machine learning model.

It should be noted that the above description is merely provided for the purposes of illustration, and not intended to limit the scope of the present disclosure. Apparently, for persons having ordinary skills in the art, multiple variations and modifications may be conducted under the teachings of the present disclosure. However, those variations and modifications do not depart from the scope of the present disclosure. In some embodiments, some other components/modules may be added into the processing engine 112. For example, the processing engine 112 may include a storage module. In some embodiments, a module may be divided into a plurality of units.

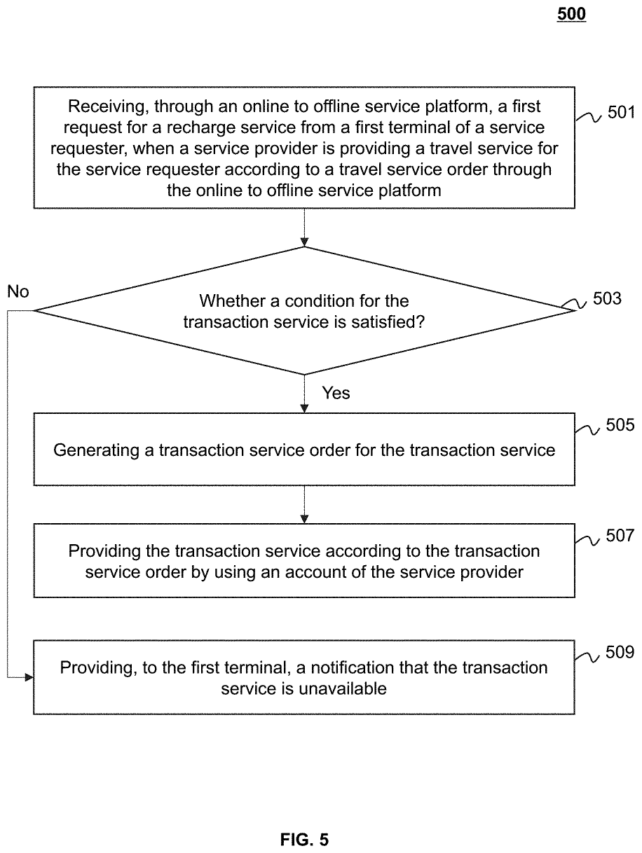

FIG. 5 is a flowchart illustrating an exemplary process for providing a transaction service according to some embodiments of the present disclosure. At least a portion of process 500 may be implemented on the computing device 200 as illustrated in FIG. 2 or the mobile device 300 as illustrated in FIG. 3. In some embodiments, one or more operations of process 500 may be implemented in the O2O service system 100 as illustrated in FIG. 1. In some embodiments, one or more operations in the process 500 may be stored in the storage device 160 and/or the storage (e.g., the ROM 230, the RAM 240, etc.) as a form of instructions, and invoked and/or executed by the server 110 (e.g., the processing engine 112 in the server 110, or the processor 220 of the processing engine 112 in the server 110). In some embodiments, the instructions may be transmitted in a form of electronic current or electrical signals.

In 501, the processing engine 112 (e.g., the acquisition module 410) may receive, through an online to offline (O2O) service platform, a request (also referred to as a first request) for the transaction service from a first terminal associated with a service requester.

The O2O service platform may be configured to provide online to offline services via a communication between terminals (e.g., the requester terminal 130, the provider terminal 140, etc.) and the O2O service platform through a network. For example, the O2O service platform may include an online travel service platform for providing travel services. In some embodiments, the O2O service platform may be implemented on a server (e.g., the server 110) for processing data/or information associated with O2O services. In some embodiments, the O2O service platform may be implemented on a terminal (e.g., the requester terminal 130, the provider terminal 140, etc.) as an application (e.g., the applications 380 as shown in FIG. 3). The O2O service platform implemented on the terminal may be configured to facilitate a communication between the online to offline system 100, a service requester, and/or a service provider. For example, the O2O service platform implemented on the terminal may include a user interface configured to facilitate a communication between the O2O service platform, a service requester, and/or a service provider. More descriptions regarding the O2O service platform may be found elsewhere in the present disclosure (e.g., FIG. 1 and the descriptions thereof).

The transaction service may be a payment on behalf of the service requester. As used herein, the service requester may be a person (e.g., a passenger) or an entity that requests the transaction service. Exemplary transaction services may include a prepaid refill service (e.g., a mobile recharge, a balance recharge for an account of the service requester, such as an account of the service requester registered in the O2O service platform, a bank account, etc.), a payment service (e.g., a payment for an online shopping, a payment for a bill (e.g., a payment for a mobile service bill, an electricity bill, an Internet fee bill, a water bill, a gas bill, etc.), a repayment service (e.g., a credit card repayment), or the like, or any combination thereof. For example, the service requester may input the first request for the mobile recharge through the O2O service platform implemented on the first terminal (e.g., the requester terminal 130), and the processing engine 112 may receive the first request for the mobile recharge through the O2O service platform. As another example, the service requester may input the first request for the balance recharge through the O2O service platform implemented on the requester terminal 130, and the processing engine 112 may receive the first request for the balance recharge through the O2O service platform.

In some embodiments, the processing engine 112 may receive, through the O2O service platform, the first request for the transaction service from the first terminal when a service provider is providing a travel service to the service requester according to a travel service order (also referred to as a travel order) through the O2O service platform. As used herein, the service provider may be a person (e.g., a driver) or an entity (e.g., autonomous vehicle, unmanned aerial vehicle, etc.) that provides the travel service. The travel service may include a taxi-hailing service, a chauffeur service, an express car service, a carpool service, a bus service, a driver hire service, a shuttle service, or the like. As used herein, “when the service provider is providing the travel service to the service requester” refers to a time period from the time the service provider receives a request for the travel service, receives the travel service order, or picks up the service requester, to the time the travel service order is finished (e.g., the time when the service requester arrives at the destination, the time when the service requester pays the travel service order, or the time when the service requester gets off, etc.). In some embodiments, “when the service provider is providing the travel service to the service requester” may also refer to the time period when the travel service order is in progress (e.g., after the service provider picks up the service requester until the service requester is dropped off).

In some embodiments, before the service requester initiates the first request for the transaction service, the service requester may initiate a request for the travel service (also referred to as a third request) through the O2O service platform implemented on the first terminal. After the service requester initiates the third request, the O2O service platform (e.g., the server 110 of the O2O service system 100) may determine one or more candidate service providers and send the third request to the one or more candidate service providers. If one of the one or more candidate service providers receives the request for the travel service, the O2O service platform may generate the travel service order, and mediate the travel service order to the service provider (e.g., a driver) and/or the service requester (e.g., a passenger). The third request may be a real-time request, a reservation request, or the like, or any combination thereof. As used herein, the real-time request may include a service that the service requester expects to receive at the present moment or at a defined time close to the present moment. For example, the third request may be a real-time request if the defined time is within a time period from the present moment, such as 5 minutes from the present moment, 10 minutes from the present moment, or 20 minutes from the present moment, etc. The reservation request may include a service that the requester expects to accept at a future time from the present moment. For example, the third request may be a reservation request if the service is scheduled in a future time, which is in a defined time period after the present moment. The defined time period may be 20 minutes after the present moment, 2 hours after the present moment, or 1 day after the present moment. In some embodiments, the processing engine 112 may define the real-time request or the reservation request based on a time threshold. The time threshold may be a default setting of the system 100, or may be adjustable according to different situations. For example, in peak traffic hours, the time threshold may be set to a lower value (e.g., 5, 10, or 15 minutes), while in off-peak hours (e.g., 10:00-12:00 a.m.), the time threshold may be set to a higher value (e.g., 45 minutes, 1 hour, or 1.5 hours).

In some embodiments, after the O2O service platform mediates the travel service order or the third request (e.g. the request for the travel service) to the service provider, the service requester may initiate the first request for the transaction service through the first terminal (e.g., the requester terminal 130), and the processing engine 112 may receive the first request for the transaction service through the O2O service platform. For example, after the O2O service system 100 mediates the travel service order to the service provider, the service requester may initiate the first request for the transaction service, no matter whether the service requester has been picked up.

In 503, the processing engine 112 (e.g., the determination module 420) may determine whether a condition for the transaction service is satisfied. In response to determining that the condition for the transaction service is satisfied, the processing engine 112 may proceed to perform operations 505 and 507. In response to determining that the condition for the transaction service is not satisfied, the processing engine 112 may proceed to perform operation 509.

In some embodiments, the processing engine 112 may determine whether the condition for the transaction service is satisfied by determining, based on first historical order data associated with the service requester, whether a first condition associated with the service requester is satisfied, determining, based on second historical order data associated with the service provider, whether a second condition associated with the service provider is satisfied, determining, based on order information of at least one of the travel service order or the transaction service order, whether a third condition associated with at least one of the travel service order or the transaction service order is satisfied, or the like, or a combination thereof.

In some embodiments, in response to determining that the first condition, the second condition, the third condition, etc., are all satisfied, the processing engine 112 may determine that the condition for the transaction service is satisfied; in response to determining that at least one of the first condition, the second condition, or the third condition, etc., is unsatisfied, the processing engine 112 may determine that the condition for the transaction service is not satisfied.

In some embodiments, in response to determining that at least one of the first condition, the second condition, or the third condition, etc., is satisfied, the processing engine 112 may determine that the condition for the transaction service is satisfied; in response to determining that none of the first condition, the second condition, and the third condition, etc., is satisfied, the processing engine 112 may determine that the condition for the transaction service is not satisfied.

The first historical order data associated with the service requester refers to information and/or data related to a plurality of historical orders initiated by the service requester through the O2O service platform. The plurality of historical orders may include one or more historical travel orders and/or historical transaction orders.

In some embodiments, the information and/or data related to a plurality of historical orders, such as data associated with a historical travel order, may include a departure location, a destination, a departure time, an arrival time, an acceptable wait time, the number of passengers, mileage information, whether to carry pets, service requester habit/preference (e.g., a vehicle type, a size of a trunk of a vehicle, a load of a vehicle, etc.), whether to accept car sharing and/or carpool, a price (e.g., an estimated price, an actual price), a price adjusted by a service provider, a price adjusted by a system, a usage of coupons, a payment way (e.g., cash payment, card payment, online payment, remittance payment, etc.), completion statuses of the first historical order, or the like, or any combination thereof. In some embodiments, the information and/or data related to the plurality of historical orders, such as data associated with a first historical transaction order, may include an amount of the first historical transaction order, an account (e.g., a recharge account, a mobile number) associated with the first historical transaction order, a transaction service carrier, the time of the historical first transaction order, etc.

In some embodiments, the information and/or data related to a plurality of historical orders may include other order related information, such as weather conditions, environmental conditions, road conditions (e.g., road closure due to security, road construction, or the like), traffic conditions, or the like, or any combination thereof.

In some embodiments, the information and/or data related to a plurality of historical orders may include statistical information related to the plurality of historical orders, timing information relating to the historical orders, or the like, or any combination thereof. The timing information relating to the historical orders may include the time that the historical orders occurred and/or the time that the historical orders spend. The statistical information related to the plurality of historical orders may include the number of the historical orders (e.g., the count of historical travel orders, the count of historical transaction orders), the number of commutes related to the historical orders, the number of historical orders placed within a particular time period (e.g., during morning and/or evening rush hours), the total fare of the historical orders (e.g., the total fare charged for the historical travel orders, the total amount of historical transaction orders), the average fare for the historical orders, etc.

In some embodiments, the information and/or data related to a plurality of historical orders may include user information, such as information associated with the service requester who requests the transaction service. The user information may include identity information, preference information r, credit information, or the like, or any combination thereof. The identity information may include a name, a nickname, a gender, a photo, a nationality, an age, a date of birth, contact information (a mobile phone number, a social media account (e.g., a Wechat™ account, a QQ™ account, a Linkedin™ account, etc.), other information that may be used to contact the user, etc.), location information (e.g., coordinate information, direction information, moving state information, etc.), an occupation, a rating, a usage time, driving experience, a vehicle age, a vehicle type, a vehicle condition, a license plate number, a driving license number, a certification status, or the like, or any combination thereof. The preference information may include a passenger's preference for a driver, a driver's preference for a passenger, a user's preference for a departure location, a user's preference for a destination, a user's preference for wait time, a user's preference for a vehicle type, or the like, or any combination thereof. The credit information may include a ratio of discontinuing orders, violation records for receiving the travel service and/or the transaction service, records of bank information, historical payment records of the user, historical evaluation for the travel service and/or the transaction service, or the like, or any combination thereof.

For example, the first historical order data may include a first count (or number) of historical orders of the service requester for the transaction service (i.e., historical transaction orders) in a time period, a second count of first historical transaction orders during the travel service order in progress, a maximum transaction amount of the service requester for receiving the transaction service, an evaluation of the service requester for receiving at least one of the travel service or the transaction service, a violation record of the service requester for receiving at least one of the travel service or the transaction service, or the like, or any combination thereof.

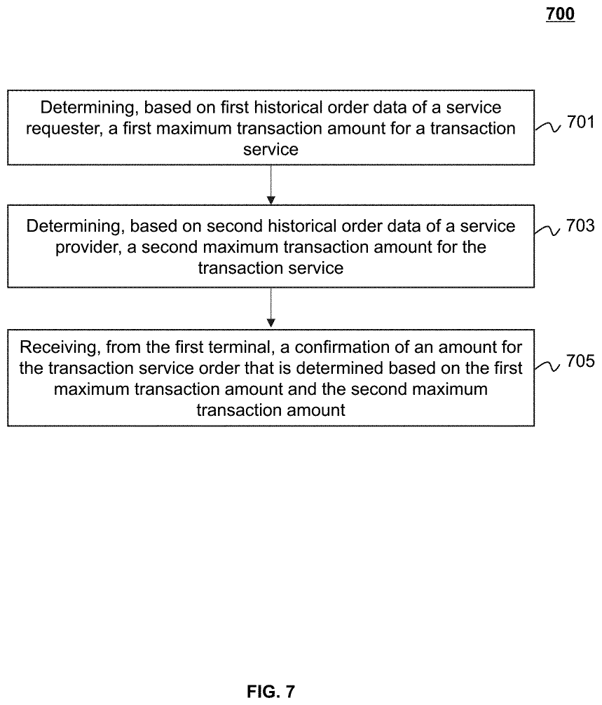

In some embodiments, the processing engine 112 may process the first historical order data. For example, the processing engine 112 may analyze the first historical order data to determine the maximum transaction amount of the service requester for receiving the transaction service based on the evaluation of the service requester for receiving at least one of the travel service or the transaction service, the violation record of the service requester for receiving at least one of the travel service or the transaction service, the first count of historical transaction orders of the service requester for the transaction service in a time period, the amount for each historical order (e.g., historical transaction orders) of the service requester for the transaction service, a total amount for historical transaction orders of the service requester during the travel service order in progress, etc. As a further example, the better the evaluation of the service requester for receiving at least one of the travel service or the transaction service is, the less the violation record of the service requester for receiving at least one of the travel service or the transaction service is, the higher the amount for each historical transaction order of the service requester for the transaction service is, the lower the total amount for historical transaction orders during the travel service order in progress is, the higher the maximum transaction amount of the service requester for receiving the transaction service may be. More descriptions for determining the maximum transaction amount of the service requester for a transaction service may be found in FIG. 7 and the description thereof.

In some embodiments, the processing engine 112 may obtain the first historical data from one or more components of the system 100 (e.g., the requester terminal 130, the provider terminal 140, the storage device 160, etc.), or from an external source (e.g., a database) via the network 120.

In some embodiments, the processing engine 112 may determine whether the first condition is satisfied by determining whether the first count of historical transaction orders of the service requester for the transaction service in the time period is less than a first predetermined order number for the service requester, determining whether the second count of historical transaction orders of the service requester for the transaction service during the travel service order in progress is less than a second predetermined order number for the service requester, determining whether the maximum transaction amount of the service requester for the transaction service exceeds a predetermined amount threshold for the service requester, determining whether the evaluation of the service requester for receiving at least one of the travel service or the transaction service satisfies an evaluation condition (also referred to as a fourth condition) for the service requester, determining whether the violation record of the service requester for receiving at least one of the travel service or the transaction service satisfies a violation condition (also referred to as a fifth condition) for the service requester, or the like, or a combination thereof.

In some embodiments, in response to determining that the first count of historical transaction orders of the service requester for the transaction service in the time period is less than the first predetermined order number, the second count of historical transaction orders of the service requester for the transaction service during the travel service order in progress is less than the second predetermined order number, the maximum transaction amount of the service requester for the transaction service is less than the predetermined amount threshold, the evaluation of the service requester for receiving at least one of the travel service or the transaction service satisfies the evaluation condition (also referred to as a fourth condition), and/or the violation record of the service requester for receiving at least one of the travel service or the transaction service satisfies the violation condition, the processing engine 112 may determine that the first condition is satisfied. For example, in response to determining that the second count of historical transaction orders of the service requester for the transaction service during the travel service order in progress is less than the second predetermined order number and the maximum transaction amount of the service requester for the transaction service is less than the predetermined amount threshold, the processing engine 112 may determine that the first condition is satisfied.

In some embodiments, the first predetermined order number, the corresponding time period, the second predetermined order number, and/or the predetermined amount threshold may be set by an operator or according to a default setting of the O2O service platform (e.g., the O2O service system 100). For example, the first predetermined order number may be 1, 2, 3, 4, 5, 6, 8, 10, etc., and the corresponding time period may be an hour, a day, a week, a month, a year, etc. The second predetermined order number may be 1, 2, 3, 4, 5, 6, 8, 10, etc. The predetermined amount threshold may be 5 dollars, 10 dollars, 15 dollars, 20 dollars, 25 dollars, 100 dollars, etc. As another example, the first predetermined order number, the second predetermined order number, and/or the predetermined amount threshold may be determined based on the first historical order data. Further, the better the evaluation of the service requester for receiving at least one of the travel service or the transaction service is, the less the violation record of the service requester for receiving at least one of the travel service or the transaction service is, the higher the amount for each historical order is, the higher the first predetermined order number may be, the higher the second predetermined order number may be, and/or the higher the predetermined amount threshold may be.

In some embodiments, the evaluation of the service requester may include a level, a score, words, etc. For example, the level may include “A,” “B,” “C,” etc., or “first level,” “second level,” “third level,” etc., or “Excellent,” “Good,” “Bad,” etc. The evaluation condition may be satisfied when the level of the evaluation is higher than a level threshold, or when the score exceeds a score threshold, or when the words of the evaluation do not include a count or number of one or more negative words, etc.

In some embodiments, the violation record may include information and/or data associated with violations, such as traffic violations, credit violations, etc. For example, the violation record of the service requester may include a count of the violations, a degree of violations, etc. The degree of the violations may be set according to a default setting of the system 100 or according to official regulations or laws. For example, the degree of the violations may include a minor violation, a moderate violation, or a serious violation. Specifically and purely as examples, a late payment may be determined as a minor violation, a persisting debt may be determined as a moderate violation, and fake information may be determined as a serious violation. As another example, the degree of the violations may include different levels (e.g., a first level, a second level, a third level, etc.), with the higher levels corresponding to more serious violations. Each of the multiple levels may correspond to one or more types of violations. In some embodiments, the processing engine 112 may determine whether the violation record of the service requester for receiving at least one of the travel service or the transaction service satisfies the violation condition by determining whether the count of the violations is less than a violation count threshold, whether the degree of the violations is lower than a violation degree threshold, and/or whether a total violation sum (multiplying violation count with violation degree, and then adding up) is lower than a violation sum threshold. In some embodiments, the violation condition (e.g., the violation count threshold, the violation degree threshold, and/or the violation sum threshold) may be set by an operator or according to a default setting of the O2O service platform (e.g., the O2O service system 100). For example, the violation count threshold may be set as 2, 4, 6, etc.; the violation degree threshold may be set as 2 or 3 (corresponding to the second or third level); and/or the violation sum threshold may be set as 4 or 6, etc.

In some embodiments, the processing engine 112 may determine, based on second historical order data associated with the service provider, whether a second condition associated with the service provider is satisfied. The second historical order data associated with the service provider refers to information and/or data related to the service provider and/or a plurality of historical orders of the service provider. The second historical order data may be similar to or same as the first historical order data. For example, the second historical order data may include a first count of historical transaction orders of the service provider for the transaction service in a time period, a second count of historical transaction orders of the service provider for the transaction service during the transaction service order in progress, a maximum transaction amount of the service provider for the transaction service, an evaluation of the service provider for providing at least one of the travel service or the transaction service, a violation record of the service provider for providing at least one of the travel service or the transaction service, or the like, or any combination thereof.

The processing engine 112 may determine whether the second condition is satisfied similar to or the same as determining whether the first condition is satisfied. For example, the processing engine 112 may determine whether the second condition is satisfied by determining whether the first count of historical transaction orders of the service provider for the transaction service in the time period is less than a first predetermined order number for the service provider, determining whether the second count of historical transaction orders of the service requester for the transaction service during the travel service order in progress is less than a second predetermined order number for the service provider, determining whether the maximum transaction amount of the service provider for the transaction service exceeds a predetermined amount threshold for the service provider, determining whether the evaluation of the service provider for providing at least one of the travel service or the transaction service satisfies an evaluation condition (also referred to as a fourth condition) for the service provider, determining whether the violation record of the service provider for providing at least one of the travel service or the transaction service satisfies a violation condition (also referred to as a fifth condition) for the service provider, or the like, or a combination thereof.

In some embodiments, in response to determining that the second count of historical transaction orders of the service provider for the transaction service in the time period is less than the first predetermined order number, the second count of historical transaction orders of the service provider for the transaction service during the travel service order in progress is less than the second predetermined order number, the maximum transaction amount of the service provider for the transaction service exceeds the predetermined amount threshold, the evaluation of the service provider for providing at least one of the travel service or the transaction service satisfies the evaluation condition (also referred to as a fourth condition), and/or the violation record of the service provider for providing at least one of the travel service or the transaction service satisfies the violation condition, the processing engine 112 may determine that the second condition is satisfied.

In some embodiments, the processing engine 112 may determine, based on order information of the transaction service order and/or the travel service order, whether the third condition associated with the transaction service order and/or the travel service order is satisfied. The order information of the transaction service order may include a desired amount of the transaction service order, a type of the transaction service order, information associated with a transaction service carrier, an account that needs to be recharged or paid, etc. The order information of the travel service order may include an origin, a destination, an estimated fare charged for the travel service order, estimated arrival time for the travel service, a type of the travel service order, etc.

In some embodiments, the type of the transaction service order may include an online payment order or a cash payment order. In some embodiments, the type of the transaction service order may include a mobile recharge order, a balance recharge order for an account of the service requester, such as an account of the service requester registered in the O2O service platform, a bank account, a payment order for an online shopping, a payment order fora bill (e.g., a living payment for an electricity bill, an Internet fee bill, a water bill, a gas bill, etc.), a repayment order (e.g., credit card repayment), etc. The type of the travel service order may include a taxi-hailing service order, a chauffeur service order, an express car service order, a carpool service order, a bus service order, a driver hire service order, a shuttle service order, etc.

In some embodiments, the processing engine 112 may determine that the third condition is satisfied in response to determining that the type of the transaction service order is a cash payment order, the type of the travel service order is not a carpool order, and/or the desired amount of the transaction service order is less than a maximum transaction amount of each of the service requester and the service provider and/or exceeds a minimum transaction amount that is a default setting of the system 100. In some embodiments, the type of the transaction service order, the type of the travel service order, and/or the desired amount of the transaction service order may be obtained from the system 100. For example, the type of the transaction service order and/or the desired amount of the transaction service order may be inputted by the service requester when the service requester initiates the travel order or the transaction order.

In some embodiments, the processing engine 112 may determine, based at least in part, on the historical order data (e.g., the first historical order data and/or the second historical order data), whether the condition for the transaction service is satisfied using a trained machine learning model. In some embodiments, the processing engine 112 may input the historical order data (e.g., the first historical order data and the second historical data) into the trained machine learning model. An output result may be generated by the trained machine learning model. The output result of the trained machine learning model may include whether the condition for the transaction service is satisfied. For example, the trained machine learning model may directly output a result indicating whether the condition for the transaction service is satisfied. As another example, the trained machine learning model may output a result of corresponding to each of the first condition, the second condition, and/or the third condition. In some embodiments, the processing engine 112 may input the first historical order data and the second historical data) respectively into the trained machine learning model and generate a result corresponding to each of the first historical order data and the second historical data.

In some embodiments, the processing engine 112 may retrieve the trained machine learning model from the requester terminal 130, the provider terminal 140, the storage device 160, or any other storage device. For example, the trained machine learning model may be determined by training a machine learning model offline based on a plurality of training samples using the processing engine 112 or a processing device other than the processing engine 112. The trained machine learning model may be stored in the requester terminal 130, the provider terminal 140, the storage device 160, or any other storage device. The processing engine 112 may retrieve the trained machine learning model from the requester terminal 130, the provider terminal 140, the storage device 160, or any other storage device in response to receipt of a request for model acquisition.

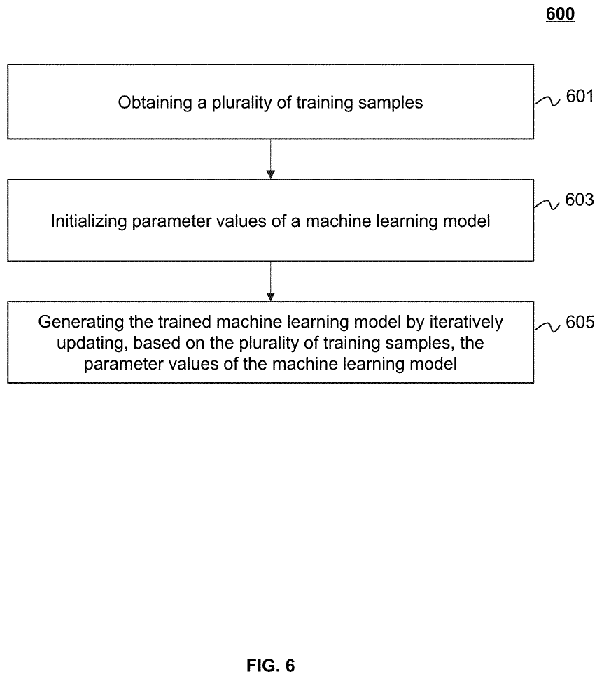

More descriptions regarding the trained machine learning model may be found in FIG. 6 and the descriptions thereof.

In 505, in response to determining that the condition is satisfied, the processing engine 112 (e.g., the generation module 430) may generate a transaction service order (also referred to as transaction order) for the transaction service.

The transaction service order may correspond to the transaction service. For example, if the transaction service is a mobile recharge, the generated transaction service order may be a mobile recharge order. As another example, if the transaction service is a balance recharge, the generated transaction service order may be a balance recharge order. In some embodiments, the transaction service order may include information and/or data related to the transaction service. Exemplary information and/or data related to the transaction service may include an amount of the transaction service order, a type of the transaction service order, a transaction service carrier, a recharge account (e.g., a mobile number), etc. In some embodiments, the information and/or data related to the transaction service may be inputted by the service requester through the O2O service platform implemented on the first terminal. In some embodiments, the information and/or data related to the transaction service may be acquired by the O2O service platform based on the second historical order data. For example, the O2O service platform may determine the transaction service carrier, the recharge account (e.g., a mobile number), etc., based on historical transaction orders of the service requester.

In some embodiments, the system 100 may provide reference information associated with the transaction service to the first terminal. The service requester may select the information and/or data related to the transaction service from the reference information, such as reference transaction amounts, reference transaction service carriers, reference recharge accounts, etc., that are determined based on historical transaction orders of the service requester. More descriptions regarding determining the amount of the transaction service order may be found in FIG. 7 and the descriptions thereof.

In 507, the processing engine 112 (e.g., the service providing module 440) may provide the transaction service according to the transaction service order by using an account of the service provider.

In some embodiments, the processing engine 112 may send the transaction order to the second terminal and receive, through the online to offline service platform, a confirmation of the transaction service order from the second terminal associated with the service provider. The confirmation of the transaction service order from the second terminal may indicate that the service provider receives an amount of cash from the service requester. For example, after the service provider (e.g., a driver) receives the amount of cash from the service requester (e.g., a passenger), the service provider may click a “confirmation button” on a user interface of the second terminal, and the processing engine 112 may receive the confirmation of the transaction service order.

In some embodiments, the processing engine 112 may send the travel order and the transaction order to the second terminal, and receive the confirmation that the service provider receives the amount of cash including the amount for the transaction service order and an amount for the travel service order from the service requester. In some embodiments, the travel order and the transaction order may be integrated into one single order. The one single order may include a total amount of the travel order and the transaction order and/or the amount of each of the travel order and the transaction order.

In some embodiments, if the service requester does not possess an account for payment of the O2O service platform (e.g., the O2O service system 100) or the account for payment of the O2O service platform of the service requester does not possess enough balance for payment of any one of the travel order and the transaction order, the transaction requester may need pay both the amount of the travel service order and the amount of the transaction service order in cash. Therefore, the processing engine 112 may transmit the notification relating to the travel service order and the transaction service order to the second terminal (e.g., the provider terminal 140). The notification may be configured to inform the service provider of the amount of cash to be charged to the service requester.

In some embodiments, if the account for payment of the O2O service platform of the service requester possesses enough balance for payment of the travel order, the service requester may need to pay the amount of the transaction service order in cash. Therefore, the processing engine 112 may transmit the notification relating to the transaction service order to the second terminal (e.g., the provider terminal 140). The notification may be configured to inform the service provider of the amount of cash to be charged to the service requester for the transaction service order.

The notification may be transmitted to the second terminal through a message, a mail, a call, the O2O service platform implemented on the second terminal, or the like, or any combination thereof.

The account of the service provider may be an account registered by the service provider on the O2O service platform (e.g., the O2O service system 100). In some embodiments, the account of the service provider may have a certain balance. The certain balance may include a credit balance and an existing balance. The credit balance may be predetermined by the system 100, for example, according to a credit evaluation of the service provider. For example, if the credit evaluation of the service provider is good, the credit balance may be much. As another example, if the credit evaluation of the service provider is bad, the credit balance may be little or zero. In some embodiments, the credit balance may be determined based on a maximum transaction amount of the service provider for the travel service and/or the transaction service. For example, the credit balance may be less than or equal to the maximum transaction amount of the service provider for the travel service and/or the transaction service. More descriptions for the maximum transaction amount of the service provider for the travel service and/or the transaction service may be found in FIG. 7 and the descriptions thereof. The existing balance refers to a real balance that the service provider possesses. For example, the existing balance may include an income from the O2O service platform via providing the travel service to service requesters.

In some embodiments, the processing engine 112 may send, by the at least one processor, a request for the transaction service to a transaction service carrier. The transaction service carrier may provide the transaction service for the service requester through the account of the service provider. Specifically, the transaction service carrier may deduct the amount for the transaction service order from the account of the service provider in response to receiving the request for the transaction service. The amount for the transaction service order deducted from the account of the service provider may be the payment on behalf of the service requester. For example, if the transaction service is a mobile recharge service, the transaction service carrier may deduct the amount for the transaction service order from the account of the service provider and recharge the amount of telephone fee for the service requester. As another example, if the transaction service is a balance recharge service, the transaction service carrier may deduct the amount for the transaction service order from the account of the service provider and recharge an amount of balance to the account of the service requester.

In 509, in response to determining that at least one of the one or more conditions is not satisfied, the processing engine 112 (e.g., the generation module 430) may provide, to the first terminal, a notification indicating that the transaction service is unavailable. In some embodiments, the notification may include a reason why the transaction service is unavailable. For example, the reason may include the first condition associated with the service requester being not satisfied, the second condition associated with the service provider being not satisfied, and/or the third condition associated with the travel service and/or the transaction service being not satisfied. As a further example, the processing engine 112 may provide the notification by pushing a message to the first terminal. The message may include “Sorry, the driver is not capable of topping up for you, please try next time,” “Sorry, this function cannot be used during a carpool order or trip, please try next time,” “Sorry, you have run out of times when you can use this function,” “Sorry, online-payment trips don't support cash top up. You can pay for this order using other payment methods,” “Sorry, you cannot top up this amount due to driver's lack of balance,” etc.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, one or more operations may be omitted and/or one or more additional operations may be added. For example, operation 501 and operation 503 may be combined into a single operation. As another example, one or more other optional operations (e.g., a storing operation) may be added elsewhere in the process 500. In the storing operation, the processing engine 112 may store information and/or data (e.g., the historical order data, the one or more conditions, the trained machine learning model, etc.) associated with the O2O service system 100 in a storage device (e.g., the storage device 160) disclosed elsewhere in the present disclosure.

FIG. 6 is a flowchart illustrating an exemplary training process of a trained machine learning model according to some embodiments of the present disclosure. At least a portion of process 600 may be implemented on the computing device 200 as illustrated in FIG. 2 or the mobile device 300 as illustrated in FIG. 3. In some embodiments, one or more operations of process 500 may be implemented in the O2O service system 100 as illustrated in FIG. 1. In some embodiments, one or more operations in the process 700 may be stored in the storage device 160 and/or the storage (e.g., the ROM 230, the RAM 240, etc.) as a form of instructions, and invoked and/or executed by the server 110 (e.g., the processing engine 112 in the server 110, or the processor 220 of the processing engine 112 in the server 110). In some embodiments, the instructions may be transmitted in a form of electronic current or electrical signals. In some embodiments, the training process of the trained machine learning model as described in FIG. 5 and/or FIG. 7 may be performed according to the process 600. For illustration purposes, a current iteration of the iteration(s) is described in the following description. The current iteration may include one or more operations of the process 600.

In 601, the processing engine 112 (e.g., the obtaining module 450) may obtain a plurality of training samples. Each of the plurality of training samples may include historical order data associated with at least one of a sample service requester or a sample service provider. More descriptions regarding the historical order data associated with at least one of the sample service requester and the sample service provider may be similar to or same as the first historical order data and the second historical order data as described in FIG. 5 and the descriptions thereof.

In some embodiments, each of the plurality of training samples may include a determination of whether a condition fora transaction service is satisfied. The historical order data corresponding to each of the training samples may be annotated by determining whether the condition for the transaction service is satisfied. For example, if the condition for the transaction service is satisfied based on the historical order data corresponding to a training sample, the training sample may be annotated as a positive sample; if the condition for the transaction service is not satisfied based on the historical order data corresponding to a training sample, the training sample may be annotated as a negative sample. In some embodiments, a positive sample may be annotated with a label “1”; a negative sample may be annotated with a label “0.” The historical order data corresponding to each of the training samples may be used as input in the training process of a machine learning model. The determination of whether the condition for the transaction service is satisfied may be used as a reference output corresponding to the historical order data of each of the training samples in the training process of the machine learning model.

In some embodiments, each of the plurality of training samples may include a maximum transaction amount of at least one of a sample service requester or a sample service provider. For example, if the historical order data includes first historical order data of a sample service requester as described in FIG. 5, each of the plurality of training samples may include the maximum transaction amount of the sample service requester; if the historical order data includes second historical order data of a sample service provider as described in FIG. 5, each of the plurality of training samples may include the maximum transaction amount of the sample service provider. The historical order data corresponding to each of the training samples may be used as input in the training process of a machine learning model. The maximum transaction amount may be used as a reference output corresponding to the historical order data of each of the training samples in the training process of the machine learning model.

In some embodiments, the reference output may be predetermined by the system 100. For example, the system 100 may be predetermined the reference output according to a default setting of the system 100 or according to the historical order data.

In 603, the processing engine 112 (e.g., the training module 460) may initialize parameter values of a machine learning model.

In some embodiments, the machine learning model to be trained may include a deep learning model (e.g., a convolutional neural network (CNN) model, a deep belief nets (DBN) machine learning model, a stacked auto-encoder network), a recurrent neural network (RNN) model, a long short term memory (LSTM) network model, a fully convolutional neural network (FCN) model, a generative adversarial network (GAN) model, a backpropagation (BP) machine learning model, a radial basis function (RBF) machine learning model, an Elman machine learning model, or the like, or any combination thereof. It should be noted that the descriptions of the machine learning model in the present disclosure are merely provided for illustration, and not intended to limit the scope of the present disclosure. In some embodiments, the machine learning model may include a multi-layer structure. For example, the machine learning model may include an input layer, an output layer, and one or more hidden layers between the input layer and the output layer. In some embodiments, the hidden layers may include one or more convolution layers, one or more rectified-linear unit layers (ReLU layers), one or more pooling layers, one or more fully connected layers, or the like, or any combination thereof. As used herein, a layer of a model may refer to an algorithm or a function for processing input data of the layer. Different layers may perform different kinds of processing on their respective input. A successive layer may use output data from a previous layer of the successive layer as input data. In some embodiments, the convolutional layer may include a plurality of kernels, which may be used to extract a feature. In some embodiments, each kernel of the plurality of kernels may filter a portion (i.e., a region). The pooling layer may take an output of the convolutional layer as an input. The pooling layer may include a plurality of pooling nodes, which may be used to sample the output of the convolutional layer, so as to reduce the computational load of data processing and accelerate the speed of data processing speed. In some embodiments, the size of the matrix representing the inputted data may be reduced in the pooling layer. The fully connected layer may include a plurality of neurons. The neurons may be connected to the pooling nodes in the pooling layer. In the fully connected layer, a plurality of vectors corresponding to the plurality of pooling nodes may be determined based on a training sample, and a plurality of weighting coefficients may be assigned to the plurality of vectors. The output layer may determine an output based on the vectors and the weighting coefficients obtained from the fully connected layer.

In some embodiments, each of the layers may include one or more nodes. In some embodiments, each node may be connected to one or more nodes in a previous layer. The number of nodes in each layer may be the same or different. In some embodiments, each node may correspond to an activation function. As used herein, an activation function of a node may define an output of the node given input or a set of inputs. In some embodiments, each connection between two of the plurality of nodes in the initial machine learning model may transmit a signal from one node to another node. In some embodiments, each connection may correspond to a weight. As used herein, a weight corresponding to a connection may be used to increase or decrease the strength or impact of the signal at the connection.

The machine learning model may include a plurality of parameters, such as architecture parameters, learning parameters, etc. Exemplary architecture parameters of the machine learning model may include the size of a kernel of a layer, the total count (or number) of layers, the count (or number) of nodes in each layer, a learning rate, a batch size, an epoch, etc. Exemplary learning parameters may include a connected weight between two connected nodes, a bias vector relating to a node, etc.). Before the training, the machine learning model may have one or more initial parameter values. In the training of the machine learning model, learning parameters of the machine learning model may be updated. Before the updating process, values of the learning parameters of the machine learning model may be initialized. For example, the connected weights and/or the bias vector of nodes of the initial machine learning model may be initialized by assigning random values in a range, e.g., the range from −1 to 1. As another example, all the connected weights of the initial machine learning model may be assigned the same value in the range from −1 to 1, for example, 0. As still an example, the bias vector of nodes in the initial machine learning model may be initialized by assigning random values in a range from 0 to 1. In some embodiments, the parameters of the initial machine learning model may be initialized based on a Gaussian random algorithm, a Xavier algorithm, etc.

In 605, the processing engine 112 (e.g., the training module 460) may generate the trained machine learning model by iteratively updating, based on the plurality of training samples, the parameter values of the machine learning model.

In the training of the machine learning model, the processing engine 112 may iteratively update the parameter value(s) of the machine learning model based on the plurality of training samples. The updating of the learning parameters of the machine learning model may be also referred to as updating the machine learning model. For example, the processing engine 112 may update the model parameter(s) of the machine learning model by performing one or more iterations until a termination condition is satisfied. The termination condition may indicate whether the machine learning model is sufficiently trained. The termination condition may relate to a cost function or an iteration count of the training process. For example, the processing engine 112 may determine a loss function of the machine learning model and determine a value of the cost function based on the difference between an estimated output and an actual output or desired output (i.e., reference output). Further, the processing engine 112 may determine the termination condition is satisfied if the value of the loss function is less than a threshold. The threshold may be default settings of the O2O service system 100 or may be adjustable under different situations. As another example, the termination condition may be satisfied if the value of the cost function converges. The convergence may be deemed to have occurred if the variation of the values of the cost function in two or more consecutive iterations is smaller than a threshold (e.g., a constant). As still another example, the processing engine 112 may determine the termination condition is satisfied if a specified number (or count) of iterations are performed in the training process. In response to a determination that the termination condition is satisfied, the processing engine 112 may designate the machine learning model with the parameter values updated in the last iteration as the trained machine learning model (e.g., the trained machine learning model). On the other hand, in response to a determination that the termination condition is not satisfied, the processing engine 112 may update at least some of the parameter values of the machine learning model based on the assessment result. For example, the processing engine 112 may update the value(s) of the learning parameter(s) of the machine learning model based on the value of the loss function according to, for example, a backpropagation algorithm. The processing engine 112 may perform the next iteration until the termination condition is satisfied. In the next iteration, the processing engine 112 may obtain multiple groups of training samples in another batch. The size of the batch may refer to a group count or number of the multiple groups of training samples. After the termination condition is satisfied in a certain iteration, the machine learning model in the certain iteration having the updated value(s) of the learning parameter(s) may be designated as the trained machine learning model (e.g., the trained machine learning model).

It should be noted that the above description is merely provided for illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, one or more operations may be omitted and/or one or more additional operations may be added. For example, one or more other optional operations (e.g., a storing operation) may be added elsewhere in the process 600. In the storing operation, the processing engine 112 may store information and/or data (e.g., parameter values, etc.) associated with the training of the machine learning model in a storage device (e.g., the storage device 160) disclosed elsewhere in the present disclosure.

FIG. 7 is a flowchart illustrating an exemplary process for determining a transaction amount according to some embodiments of the present disclosure. At least a portion of process 700 may be implemented on the computing device 200 as illustrated in FIG. 2 or the mobile device 300 as illustrated in FIG. 3. In some embodiments, one or more operations of process 700 may be implemented in the O2O service system 100 as illustrated in FIG. 1. In some embodiments, one or more operations in the process 700 may be stored in the storage device 160 and/or the storage (e.g., the ROM 230, the RAM 240, etc.) as a form of instructions, and invoked and/or executed by the server 110 (e.g., the processing engine 112 in the server 110, or the processor 220 of the processing engine 112 in the server 110). In some embodiments, the instructions may be transmitted in a form of electronic current or electrical signals. In some embodiments, one or more operations of the process 700 may be performed to achieve at least part of operation 503 and/or operation 505 as described in connection with FIG. 5.

In 701, the processing engine 112 (e.g., the determination module 420) may determine, based on first historical order data of a service requester, a first maximum transaction amount for a transaction service.

The first historical order data of the service requester refers to information and/or data related to a plurality of the first historical orders of the service requester. More descriptions regarding the first historical order data of the service requester may be found in FIG. 5 and the descriptions thereof. For example, the first historical order data of the service requester may include data of historical transaction orders and/or data of historical travel orders of the service requester provided by an online to offline service platform as described elsewhere in the present disclosure.

In some embodiments, the processing engine 112 may determine the first maximum transaction amount for the transaction service by preprocessing the first historical order data. For example, the processing engine 112 may analyze the first historical order data to determine the first maximum transaction amount of the service requester based on an evaluation of the service requester for receiving at least one of a travel service or the transaction service, a violation record of the service requester for receiving at least one of the travel service or the transaction service, a first count of historical transaction orders of the service requester for the transaction service in a time period, an amount for each historical order (e.g., each historical transaction order), a total amount for historical transaction orders during the travel service order in progress, etc. As a further example, the better the evaluation of the service requester for receiving at least one of the travel service or the transaction service is, the less the violation record of the service requester for receiving at least one of the travel service or the transaction service is, the higher the amount for each historical transaction order is, the lower the total amount for historical transaction orders during the travel service order in progress is, the higher the first maximum transaction amount of the service requester for receiving the transaction service may be. In some embodiments, the first maximum transaction amount of the service requester may be set as a first threshold by an operator or according to a default setting of the O2O service platform (e.g., the O2O service system 100). For example, the first threshold may be 5 dollars, 10 dollars, 15 dollars, 20 dollars, 25 dollars, 100 dollars, etc.

In some embodiments, the processing engine 112 may determine a candidate first maximum transaction amount based on the first historical order data of a service requester. The candidate first maximum transaction amount may include a sum of the first maximum transaction amount for the transaction service and an estimated amount for a travel order when the service requester requests the transaction service in progress of the travel order. The processing engine 112 may determine the first maximum transaction amount for the transaction service based on the candidate first maximum transaction amount and the estimated amount for the travel order. The estimated amount for the travel order may be determined based on information of the travel order, such as the destination, the starting location, a travel distance, etc., according to a pricing algorithm of the system 100.

In some embodiments, the processing engine 112 may determine the first maximum transaction amount using a trained machine learning model. For example, the processing engine 112 may input historical transaction orders or the first historical order data of the service requester into the trained machine learning model and the trained machine learning model may generate the first maximum transaction amount or the candidate first maximum transaction amount based on the inputted data. In some embodiments, the processing engine 112 may retrieve the trained machine learning model for determining a maximum transaction amount from the requester terminal 130, the provider terminal 140, the storage device 160, or any other storage device. For example, the trained machine learning model may be determined by training a machine learning model offline based on a plurality of training samples using the processing engine 112 or a processing device other than the processing engine 112. The trained machine learning model may be stored in the requester terminal 130, the provider terminal 140, the storage device 160, or any other storage device. The processing engine 112 may retrieve the trained machine learning model from the requester terminal 130, the provider terminal 140, the storage device 160, or any other storage device in response to receipt of a request for model acquisition. More descriptions regarding the training of the trained machine learning model may be found in FIG. 6 and the descriptions thereof.

In 703, the processing engine 112 (e.g., the determination module 420) may determine, based on second historical order data of the service provider, a second maximum transaction amount for the transaction service.

The second historical order data of the service provider refers to information and/or data related to a plurality of the second historical orders of the service provider. More descriptions regarding the second historical order data of the service provider may be found in FIG. 5 and the descriptions thereof. For example, the second historical order data of the service provider may include data of historical transaction orders and/or data of historical travel orders of the service provider provided by the online to offline service platform as described elsewhere in the present disclosure.

In some embodiments, the processing engine 112 may determine the second maximum transaction amount for the transaction service by preprocessing the second historical order data. For example, the processing engine 112 may analyze the second historical order data to determine the second maximum transaction amount of the service provider for receiving the transaction service based on an evaluation of the service provider for receiving at least one of the travel service or the transaction service, a violation record of the service provider for receiving at least one of the travel service or the transaction service, a first count of historical transaction orders of the service provider for the transaction service in a time period, an amount for each historical order (e.g., each historical transaction order), a total amount for historical transaction orders during the travel service order in progress, etc. As a further example, the better the evaluation of the service provider for receiving at least one of the travel service or the transaction service is, the less the violation record of the service provider for receiving at least one of the travel service or the transaction service is, the higher the amount for each historical order (e.g., each historical transaction order, each historical travel order, or an integrated order including a historical transaction order and a historical travel order of the service provider) is, the lower the total amount for second historical transaction orders during the travel service order in progress is, the higher the second maximum transaction amount of the service provider for receiving the transaction service may be. In some embodiments, the second maximum transaction amount of the service provider may be set as a second threshold by an operator or according to a default setting of the O2O service platform (e.g., the O2O service system 100). For example, the second threshold may be 5 dollars, 10 dollars, 15 dollars, 20 dollars, 25 dollars, 100 dollars, etc. Alternatively or additionally, the second threshold may be the same as or different from the first threshold.

In some embodiments, the processing engine 112 may determine a candidate second maximum transaction amount based on the second historical order data of the service provider. The candidate second maximum transaction amount may include a sum of the second maximum transaction amount for the transaction service and the estimated amount for the travel order when the service requester requests the transaction service in progress of the travel order. The processing engine 112 may determine the second maximum transaction amount for the transaction service based on the candidate second maximum transaction amount and the estimated amount for the travel order.

In some embodiments, the processing engine 112 may determine the second maximum transaction amount using a trained machine learning model. For example, the processing engine 112 may input historical transaction orders or the second historical order data of the service provider into the trained machine learning model and the trained machine learning model may generate the second maximum transaction amount or the candidate second maximum transaction amount based on the inputted data. More descriptions regarding the training of the trained machine learning model may be found in FIG. 6 and the descriptions thereof.

In 705, the processing engine 112 (e.g., the service providing module 440) may receive, from the first terminal, a confirmation of an amount for the transaction service order that is determined based on the first maximum transaction amount and the second maximum transaction amount.

In some embodiments, the processing engine 112 may provide, based on the first maximum transaction amount and the second maximum transaction amount, one or more reference transaction amounts for the service requester. The amount for the transaction service order may be selected from the one or more reference transaction amounts by the service requester.

In some embodiments, the one or more reference transaction amounts for the service requester may be smaller than or equal to a minimum amount among the first maximum transaction amount and the second maximum transaction amount. Alternatively or additionally, the one or more reference transaction amounts may include any value from 0 to the minimum amount among the first maximum transaction amount and the second maximum transaction amount, such as, half of the minimum amount, a third of the minimum amount, a fourth of the minimum amount, a fifth of the minimum amount, etc. In some embodiments, the processing engine 112 may provide the one or more reference transaction amounts for the service requester. For example, the processing engine 112 may provide the one or more reference transaction amounts for the service requester through a plurality of select boxes on a display screen of a first terminal (e.g., the requester terminal 130).

In some embodiments, the service requester may directly input the amount of the transaction service order and the amount of the transaction service order may be less than the first maximum transaction amount and the second maximum transaction amount. The processing engine 112 may receive, from the first terminal, the confirmation of the amount for the transaction service order inputted by the service requester.

In response to receiving the confirmation of the amount for the transaction service order and/or other information related to the transaction service, the processing engine 112 may generate the transaction service order.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, one or more operations may be omitted and/or one or more additional operations may be added. For example, one or more other optional operations (e.g., a storing operation) may be added elsewhere in the process 700. In the storing operation, the processing engine 112 may store information and/or data (e.g., the first maximum transaction amount and the second maximum transaction amount, the one or more reference transaction amounts, etc.) associated with the O2O service system 100 in a storage device (e.g., the storage device 160) disclosed elsewhere in the present disclosure.

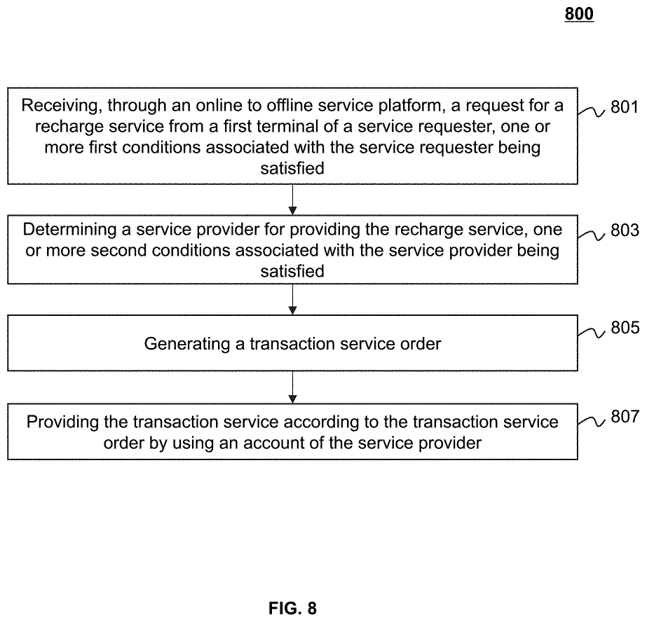

FIG. 8 is a flowchart illustrating an exemplary process for providing a transaction service according to some embodiments of the present disclosure. At least a portion of process 800 may be implemented on the computing device 200 as illustrated in FIG. 2 or the mobile device 300 as illustrated in FIG. 3. In some embodiments, one or more operations of process 800 may be implemented in the O2O service system 100 as illustrated in FIG. 1. In some embodiments, one or more operations in the process 800 may be stored in the storage device 160 and/or the storage (e.g., the ROM 230, the RAM 240, etc.) as a form of instructions, and invoked and/or executed by the server 110 (e.g., the processing engine 112 in the server 110, or the processor 220 of the processing engine 112 in the server 110). In some embodiments, the instructions may be transmitted in a form of electronic current or electrical signals.

In 801, the processing engine 112 (e.g., the acquisition module 410) may receive, through an online to offline service platform, a request for a transaction service from a first terminal of a service requester.

As used herein, the transaction service may be a payment on behalf of the service requester. More descriptions regarding the transaction service may be found in FIG. 5 and the descriptions thereof.

In some embodiments, the processing engine 112 may determine whether one or more first conditions associated with the service requester are satisfied. In response to determining that the one or more first conditions are satisfied, the processing engine 112 may perform operation 803. In response to determining that the one or more first conditions are not satisfied, the processing engine 112 may provide, to the first terminal, a notification indicating that the transaction service is unavailable for the service requester. More descriptions regarding the determination of whether the one or more first conditions are satisfied may be found in FIG. 5 and the descriptions thereof.

In 803, the processing engine 112 (e.g., the determination module 420) may determine a service provider for providing the transaction service.

In some embodiments, the processing engine 112 may determine one or more candidate service providers based on the location of the service requester and the location of each of the one or more candidate service providers. In some embodiments, a time duration traveling from the location of each candidate service provider to the location of the service requester may be less than a time threshold. In some embodiments, a travel distance between the location of each candidate service provider and the location of the service requester may be less than a first distance threshold. In some embodiments, a straight line distance between the location of each candidate service provider and the location of the service requester may be less than a second distance threshold.

In some embodiments, the processing engine 112 may determine whether one or more second conditions associated with each of the candidate service providers are satisfied. More descriptions regarding the determination of whether one or more second conditions are satisfied may be found in FIG. 5 and the descriptions thereof.

In some embodiments, the processing engine 112 may determine one or more candidate service providers who are satisfied the one or more second conditions, and send the request for transaction service to the second terminal associated with each of the one or more candidate service providers. In response to receipt of the request for the transaction service from a candidate service provider, the processing engine 112 may determine the candidate service provider as the service provider for providing the transaction service.

In some embodiments, the processing engine 112 may determine a nearest service provider from the service requester and determine whether the one or more second conditions associated with the nearest service provider are satisfied. If the one or more second conditions associated with the nearest service provider are satisfied, the processing engine 112 may send the request for the transaction service to the second terminal of the nearest service provider, and if the nearest service provider receives the request for the transaction service, the processing engine 112 may determine the nearest service provider for providing the transaction service. If the one or more second conditions associated with the nearest service provider are not satisfied or the nearest service provider refuses the request for the transaction service, the processing engine 112 may determine another nearest service provider and determine whether the one or more second conditions associated with the another nearest service provider are satisfied until the service provider may be determined.

In 805, the processing engine 112 (e.g., the generation module 430) may generate a transaction service order.

The transaction service order may correspond to the transaction service. The transaction service order may include the amount of the transaction service, information related to a transaction service carrier, information related to an account of the service requester to be recharged, etc. More descriptions regarding the transaction service order may be found in FIG. 5 and the descriptions thereof. In some embodiments, after the transaction service order generates, the processing engine 112 may further send, through the online to offline service platform, the transaction service order to a second terminal (e.g., the provider terminal 140) of the service provider.

In 807, the processing engine 112 (e.g., the service providing module 440) may provide the transaction service according to the transaction service order by using an account of the service provider.

In some embodiments, the processing engine 112 may receive, through the online to offline service platform, a confirmation of the transaction service order from the second terminal associated with the service provider. The confirmation of the transaction service order from the second terminal may indicate that the service provider receives an amount of cash from the service requester. The amount of cash may include an amount for the transaction service order.

The account of the service provider may be an account registered by the service provider on the O2O service platform (the O2O service system 100). More descriptions regarding the account of the service provider may be found in FIG. 5 and the descriptions thereof. In some embodiments, the processing engine 112 may provide the transaction service by sending a request for the transaction service to a transaction service carrier. The transaction service carrier may provide the transaction service for the service requester through the account of the service provider. Specifically, the transaction service carrier may deduct the amount for the transaction service order from the account of the service provider in response to receiving the request for the transaction service. For example, if the transaction service is a mobile recharge service, the transaction service carrier may deduct the amount for the transaction service order from the account of the service provider and recharge the amount of telephone fee for the service requester. As another example, if the transaction service is a balance recharge service, the transaction service carrier may deduct the amount for the transaction service order from the account of the service provider and recharge an amount of balance to the account of the service requester.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, one or more operations may be omitted and/or one or more additional operations may be added. For example, operation 801 and operation 803 may be combined into a single operation. As another example, one or more other optional operations (e.g., a storing operation) may be added elsewhere in the process 800. In the storing operation, the processing engine 112 may store information and/or data (e.g., the historical order data, the one or more conditions, etc.) associated with the O2O service system 100 in a storage device (e.g., the storage device 160) disclosed elsewhere in the present disclosure.

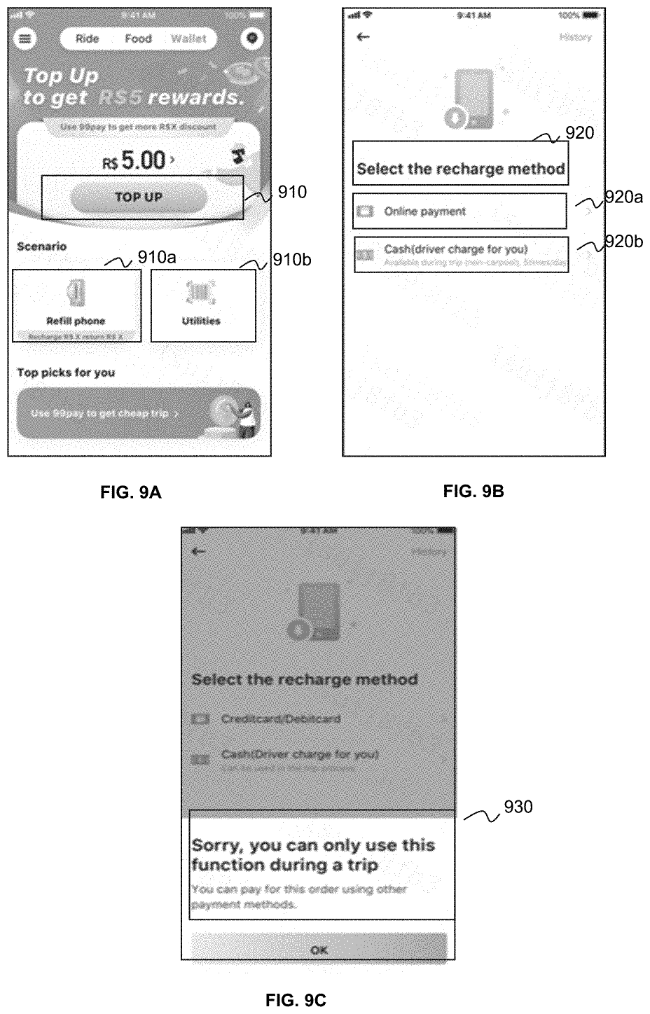

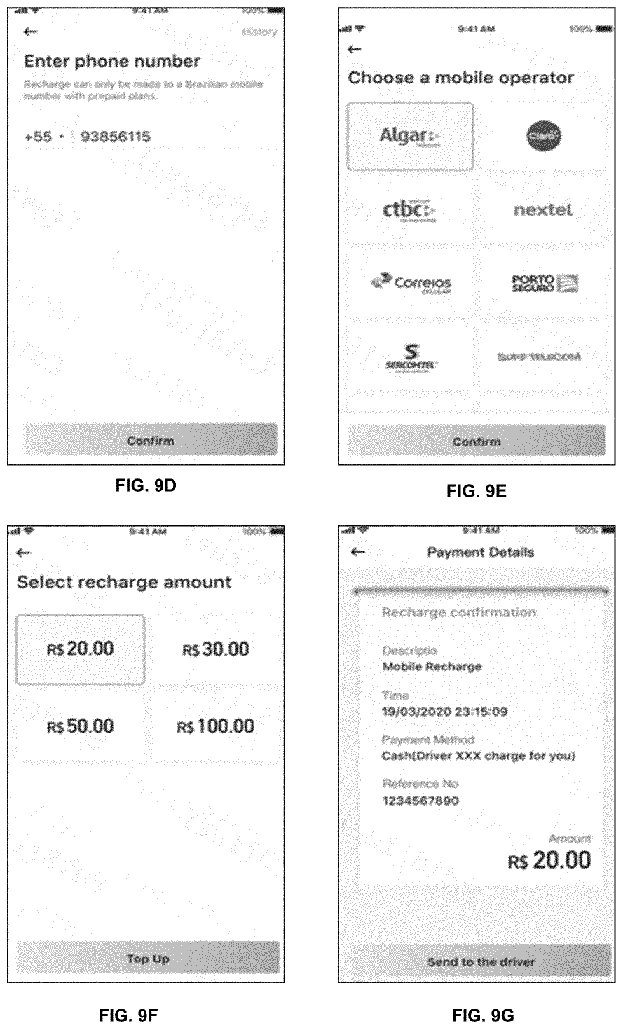

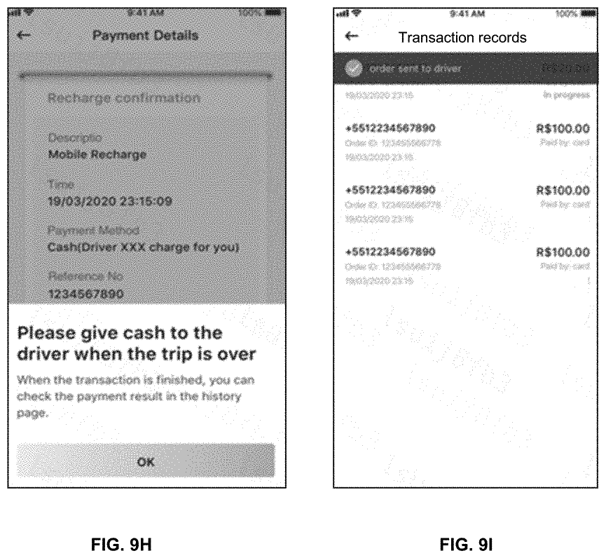

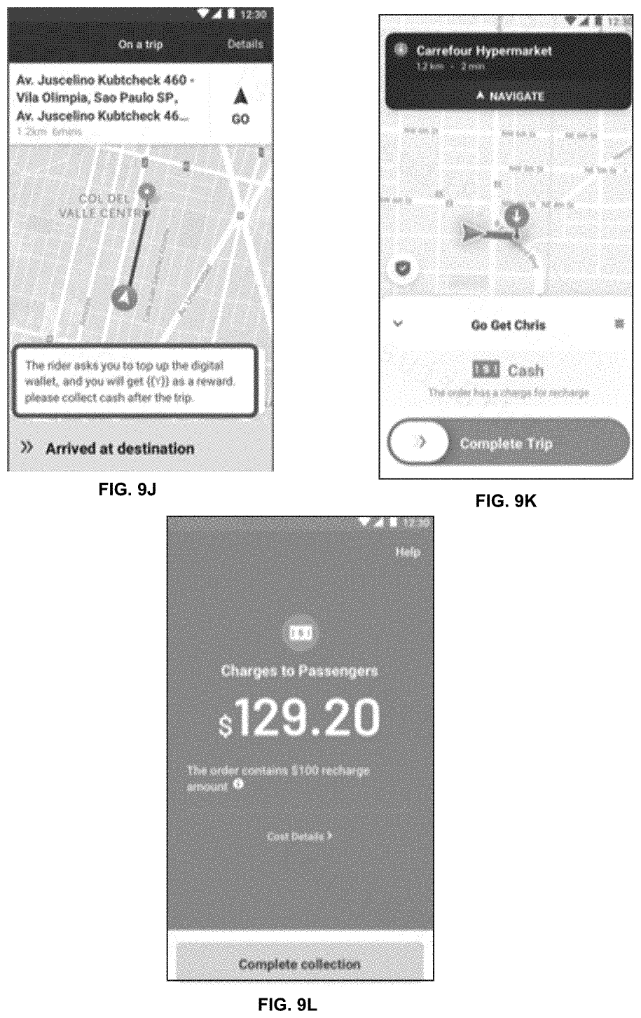

FIGS. 9A-9L are block diagrams illustrating an exemplary process for providing a transaction service through user interfaces of terminal devices according to some embodiments of the present disclosure. The user interface may be implemented on terminal devices (e.g., the requester terminal 130, the provider terminal 140). The terminal device (e.g., the requester terminal 130, the provider terminal 140) may be connected to and/or communicate with a server 110, a vehicle 150, and/or a storage device 160. In some embodiments, the terminal device may include a mobile device, a tablet computer, a laptop computer, or the like, or a combination thereof. For example, the mobile device may include a mobile phone, a personal digital assistant (PDA), a gaming device, a navigation device, a point of sale (POS) device, a laptop, a tablet computer, a desktop, or the like, or a combination thereof. In some embodiments, the terminal device may include an input device, an output device (e.g., the display 320 as illustrated in FIG. 3), etc., as described elsewhere in the present disclosure (e.g., FIG. 1 and the descriptions thereof).

The user interface may be implemented on the terminal devices (e.g., the requester terminal, the provider terminal) as applications. The user interface may facilitate communication between a user (e.g., a service requester, a service provider, etc.) and one or more components (e.g., the processing engine 112 and terminals) in the O2O service system 100. For example, the requester terminal 130 may acquire an input of the service requester indicating an operation for requesting a transaction service (e.g., a mobile recharge, a balance recharge, etc.) and transmit the input of the service requester indicating the operation to the processing engine 112. As another example, the processing engine 112 may determine whether a condition for the transaction service is satisfied and transmit the determination to the requester terminal 130. The determination may be displayed for the service requester via the user interface.

As illustrated in FIGS. 9A-9I, the user interface may provide representations of one or more modules implemented on the requester terminal 130 and/or on the provider terminal 140, such as a transaction service selection module 910, a recharge method selection module 920, etc. Each of the modules described above may be implemented by a hardware circuit (e.g., the processing engine 112, the CPU 340, etc.) that is designed to perform certain actions, e.g., according to a set of instructions stored in one or more storage media, and/or any combination of the hardware circuit and the one or more storage media. A module may be presented on the user interface as an icon, a text, a button, etc. In some embodiments, when the user selects a module or unit via the user interface, the module or unit may perform corresponding actions, e.g., according to a set of instructions stored in one or more storage media. For example, when the user clicks or touches the icon representing the transaction service selection module 910, the transaction service selection module 910 may provide a plurality of transaction services to be selected. It should be noted that the descriptions of the requester terminal 130 and/or the provider terminal 140 in the present disclosure are merely provided for the purposes of illustration, and not intended to limit the scope of the present disclosure.

FIGS. 9A-9I are diagrams illustrating an exemplary process for requesting a transaction service through a user interface implemented on a requester terminal according to some embodiments of the present disclosure. As shown in FIG. 9A, the transaction service selection module 910 may be configured to provide a plurality of transaction services to be selected for the service requester. Exemplary transaction services may include a mobile recharge, a balance recharge for an account of the service requester, such as an account of the service requester registered in the O2O service platform, a bank account, a payment for an online shopping, a payment for a bill (e.g., a living payment for an electricity bill, an Internet fee bill, a water bill, a gas bill, etc.), or the like, or any combination thereof. In some embodiments, the transaction service selection module 910 may further include a common transaction service unit 910a and a recommend transaction service unit 910b. The common transaction service unit 910a may be a type of a transaction service that the service requester often uses. In some embodiments, the common transaction service unit 910a may be determined according to a frequency of each type of transaction services. For example, the common transaction service unit 910a may be the most used transaction service in the past month. In some embodiments, the common transaction service unit 910a may be set by the service requester. The recommend transaction service unit 910b may be a type of a transaction service that the O2O service system 100 recommends. For example, the recommend transaction service unit 910b may be a type of transaction service that the O2O service system 100 is promoting.

As shown in FIG. 9B, after the service requester selects a type of a transaction service, such as “Refill phone,” the user interface may provide the recharge method selection module 920 on the display of the requester terminal 130. The following descriptions are provided regarding the transaction service as the “Refill phone” unless otherwise stated. It should be noted that the descriptions of “Refill phone” in the present disclosure are merely provided for illustration, and not intended to limit the scope of the present disclosure.

The recharge method selection module 920 may be configured to provide a plurality of recharge methods for the service requester. Merely by way of example, the recharge method selection module 920 may include an online payment unit 920a and a cash unit 920b. The online payment unit 920a may indicate that the service requester may pay an amount of the transaction service through an account of the service requester registered on the O2O service system 100. The cash unit 920b may indicate that the service requester may pay the amount of the transaction service using the cash and the service provider may use an account of the service provider to pay the amount of the transaction service online after receiving the cash from the service requester.

After the cash unit 920b is selected by the service requester, the processing engine 112 may determine whether a condition for the transaction service is satisfied. More descriptions regarding the determination may be found in FIG. 5 and the descriptions thereof.

In response to determining that the condition for the transaction service is not satisfied, the processing engine 112 may provide a notification indicating that the transaction service is unavailable to the requester terminal 130 through the reason display module 930. In some embodiments, the reason display module 930 may be configured to display one or more reasons why the transaction service is unavailable for the service requester. For example, the reason display module 930 may display a text including “Sorry, the driver is not capable of topping up for you, please try next time,” “Sorry, this function cannot be used during a carpool trip, please try next time,” “Sorry, you have run out of times when you can use this function,” “Sorry, online-payment trips don't support cash top up. You can pay for this order using other payment methods,” “Sorry, you cannot top up this amount due to driver's lack of balance,” etc.

In response to determining that the condition for the transaction service is satisfied, an information input module may be configured to input the information of the transaction service by the service requester. The service requester may input or select information (i.e., details information) of the transaction service. As shown in FIGS. 9D-9F, the service requester may input the phone number, select a mobile operator from reference mobile operators displayed on the requester terminal 130, and select a recharge amount from reference amounts. In some embodiments, the service requester may input the mobile number by retrieving a telephone directory or an application program. After the information of the transaction service is determined, the processing engine 112 may generate a transaction service order and send the transaction service order to the requester terminal 130 for confirmation by the service requester as shown in FIG. 9G. The service requester may click a button representing “send to the driver” after confirming the information of the transaction service order. The processing engine 112 may send the transaction service order to the provider terminal 140. After sending the transaction service order to the provider terminal 140, the processing engine 112 may provide a notification on the user interface of the requester terminal as shown in FIG. 9H, and the notification may prompt the service requester to give cash to the service provider (e.g., a driver) when the travel service is finished. After the service requester gives the amount of cash to the service provider, the processing engine 112 may provide a notification indicating whether the transaction service succeeds on the user interface of the requester terminal as shown in FIG. 9I. The service requester may check the transaction order status.

FIGS. 9J-9L are diagrams illustrating an exemplary process for providing a transaction service through a user interface implemented on a provider terminal according to some embodiments of the present disclosure. As shown in FIG. 9J, the processing engine 112 may send a notification relating to the transaction service order to the provider terminal 140. As shown in FIG. 9K, the notification relating to the transaction service order may prompt the service provider that the service requester may pay for the transaction service in cash. As shown in FIG. 9L, the notification relating to the transaction service order may prompt the amount for the transaction service order and/or the amount for the travel order. At the end of the trip, the service provider may collect the amount of cash from the service requester and confirm through the user interface that the amount of cash has been collected from the service requester. After the processing engine 112 receive the confirmation indicating that the service provider collects the amount of cash from the service requester, the processing engine 112 may provide the transaction service for the service requester by using the account of the service provider.

It should be noted that the above description is merely provided for illustration, and not intended to limit the scope of the present disclosure. Apparently, for persons having ordinary skills in the art, multiple variations and modifications may be conducted under the teachings of the present disclosure. However, those variations and modifications do not depart from the scope of the present disclosure. For example, the transaction service selection module 910 and the recharge method selection module 920 may be integrated into a single module. As another example, some other components/modules may be added into the processing engine 112.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure, or characteristic described in connection with the embodiment is included in at least one embodiment of the present disclosure. Therefore, it is emphasized and should be appreciated that two or more references to “an embodiment,” “one embodiment,” or “an alternative embodiment” in various portions of this specification are not necessarily all referring to the same embodiment. Furthermore, the particular features, structures, or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “block,” “module,” “engine,” “unit,” “component,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C #, VB. NET, Python, or the like, conventional procedural programming languages, such as the “C” programming language, Visual Basic, Fortran 1703, Perl, COBOL 1702, PHP, ABAP, dynamic programming languages such as Python, Ruby, and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a software as a service (SaaS).

Furthermore, the recited order of processing elements or sequences, or the use of numbers, letters, or other designations, therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software-only solution—e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

What is claimed is:

1. A system for providing a transaction service when a service provider is providing a travel service to a service requester according to a travel service order through an online to offline service platform, the system comprising:
at least one storage device storing executable instructions, and
at least one processor in communication with the at least one storage device, when executing the executable instructions, causing the system to perform operations including:
receiving, through the online to offline service platform, a first request for the transaction service from a first terminal associated with the service requester, when a service provider is providing the travel service to the service requester;
determining whether a condition for the transaction service is satisfied;
in response to determining that the condition is satisfied,
generating a transaction service order for the transaction service; and
providing the transaction service according to the transaction service order by using an account of the service provider.

2. The system of claim 1, wherein the transaction service is a payment on behalf of the service requester.

3. The system of claim 1, wherein the operations further include:
receiving, through the online to offline service platform, a confirmation of the transaction service order from a second terminal associated with the service provider, wherein the confirmation of the transaction service order indicates that the service provider receives an amount of cash from the service requester.

4. The system of claim 3, wherein the operations further include:
transmitting a notification relating to the travel service order and the transaction service order to the second terminal; and
receiving the confirmation that the service provider receives the amount of cash including an amount for the transaction service order and an amount for the travel service order from the service requester.

5. The system of claim 1, wherein the operations further include:
sending, by the at least one processor, a second request for the transaction service to a transaction service carrier, the transaction service carrier deducting an amount for the transaction service order from the account of the service provider in response to receiving the second request.

6. The system of claim 1, wherein the generating a transaction service order for the transaction service includes:
determining, based on first historical order data of the service requester, a first maximum transaction amount for the transaction service;
determining, based on second historical order data of the service provider, a second maximum transaction amount for the transaction service;
providing, based on the first maximum transaction amount and the second maximum transaction amount, one or more reference transaction amounts for the service requester to select from; and
receiving, from the first terminal, a confirmation of an amount for the transaction service order that is selected from the one or more reference transaction amounts by the service requester.

7. The system of claim 1, wherein the generating a transaction service order for the transaction service includes:
determining, based on first historical order data of the service requester, a first maximum transaction amount for the transaction service;
determining, based on second historical order data of the service provider, a second maximum transaction amount for the transaction service; and
receiving, from the first terminal, a confirmation of an amount for the transaction service order inputted by the service requester, wherein the amount of the transaction service order is less than the first maximum transaction amount and the second maximum transaction amount.

8. The system of claim 1, wherein the condition for the transaction service is determined to be satisfied when one or more of the following are satisfied:
determining, based on first historical order data associated with the service requester, whether a first condition associated with the service requester is satisfied;
determining, based on second historical order data associated with the service provider, whether a second condition associated with the service provider is satisfied; and
determining, based on order information of at least one of the travel service order or the transaction service order, whether a third condition associated with at least one of the travel service order or the transaction service order is satisfied.

9. The system of claim 8, wherein the first condition is associated with at least one of:
a first count of historical orders of the service requester for the transaction service in a time period being less than a first predetermined order number for the service requester,
a second count of historical orders of the service requester for the transaction service during the travel service order in progress being less than a second predetermined order number for the service requester,
a maximum transaction amount of the service requester for the transaction service exceeding a predetermined amount threshold for the service requester,
an evaluation of the service requester for receiving at least one of the travel service or the transaction service satisfying an evaluation condition for the service requester, or
a violation record of the service requester for receiving at least one of the travel service or the transaction service satisfying a violation condition for the service requester.

10. The system of claim 8, wherein the second condition is associated with at least one of:
a first count of historical orders of the service provider for the transaction service in a time period being less than a first predetermined order number for the service provider,
a second count of historical orders of the service provider for the transaction service during the transaction service order in progress being less than a second predetermined order number for the service provider,
a maximum transaction amount of the service provider for the transaction service exceeding a predetermined amount threshold for the service provider,
an evaluation of the service provider for providing at least one of the travel service or the transaction service satisfies an evaluation condition for the service provider, or
a violation record of the service provider for providing at least one of the travel service or the transaction service satisfies a violation condition for the service provider.

11. The system of claim 8, wherein the third condition is associated with a type of the travel service order.

12. The system of claim 1, wherein the determining whether a condition for the transaction service is satisfied includes:
obtaining a trained machine learning model and historical order data associated with at least one of the service requester or the service provider; and
determining, based at least in part, on the historical order data, whether the condition for the transaction service is satisfied using the trained machine learning model.

13. A system, comprising:
at least one storage device storing executable instructions, and
at least one processor in communication with the at least one storage device, when executing the executable instructions, causing the system to perform operations including:
receiving, through an online to offline service platform, a request for a transaction service from a first terminal of a service requester, one or more first conditions associated with the service requester being satisfied, wherein the transaction service is a payment on behalf of the service requester;
determining a service provider for providing the transaction service, one or more second conditions associated with the service provider being satisfied;
generating a transaction service order; and
providing the transaction service according to the transaction service order by using an account of the service provider.

14. The system of claim 13, wherein the operations further include:
sending, through the online to offline service platform, the transaction service order to a second terminal of the service provider; and
receiving, through the online to offline service platform, a confirmation of the transaction service order from a second terminal associated with the service provider, wherein the confirmation of the transaction service order from the second terminal indicates that the service provider receives an amount of cash from the service requester.

15. The system of claim 13, wherein the first condition is associated with at least one of:
a count of historical orders of the service requester for the transaction service in a time period being less than a predetermined order number,
a maximum transaction amount of the service requester for the transaction service exceeding a predetermined amount threshold,
an evaluation of the service requester for receiving the transaction service satisfying an evaluation condition, or
a violation record of the service requester for receiving the transaction service satisfying a violation condition.

16. The system of claim 13, wherein the second condition is associated with at least one of:
a count of historical orders of the service provider for the transaction service in a time period being less than a predetermined order number,
a maximum transaction amount of the service provider for the transaction service exceeds a predetermined amount threshold,
an evaluation of the service provider for providing the transaction service satisfies an evaluation condition, or
a violation record of the service provider for providing the transaction service satisfies a violation condition.

17. The system of claim 13, wherein the generating a transaction service order for the transaction service includes:
determining, based on first historical order data of the service requester, a first maximum transaction amount for the transaction service;
determining, based on second historical order data of the service provider, a second maximum transaction amount for the transaction service; and
receiving, from the first terminal, a confirmation of an amount for the transaction service order inputted by the service requester, wherein the amount of the transaction service order is less than the first maximum transaction amount and the second maximum transaction amount.

18. A method for providing a transaction service when a service provider is providing a travel service to a service requester according to a travel service order through an online to offline service platform, the method being implemented on a computing device including at least one processor and a storage device, the method comprising:
receiving, through the online to offline service platform, a first request for a transaction service from a first terminal associated with the service requester, when a service provider is providing the travel service to the service requester;
determining whether a condition for the transaction service is satisfied;
in response to determining that the condition is satisfied,
generating a transaction service order for the transaction service; and
providing the transaction service according to the transaction service order by using an account of the service provider.

19. The method of claim 18, wherein the method further includes:
receiving, through the online to offline service platform, a confirmation of the transaction service order from a second terminal associated with the service provider, wherein the confirmation of the transaction service order indicates that the service provider receives an amount of cash from the service requester.

20. The method of claim 18, wherein the condition for the transaction service is satisfied when one or more of the following are satisfied:
determining, based on first historical order data associated with the service requester, whether a first condition associated with the service requester is satisfied;
determining, based on second historical order data associated with the service provider, whether a second condition associated with the service provider is satisfied; and
determining, based on order information of at least one of the travel service order or the transaction service order, whether a third condition associated with at least one of the travel service order or the transaction service order is satisfied.
